(19) United States
(12) Patent Application Publication
(10) Pub. No.: US 2014/0344679 A1
(43) Pub. Date: Nov. 20, 2014

(54) SYSTEMS AND METHODS FOR CREATING A DOCUMENT

(71) Applicant: Kwatros Corporation, Salt Lake City, UT (US)

(72) Inventors: Glen A. Larsen, Sandy, UT (US); Justin B. Rich, Salt Lake City, UT (US)

(21) Appl. No.: 14/280,374

(22) Filed: May 16, 2014

Related U.S. Application Data
(60) Provisional application No. 61/824,890, filed on May 17, 2013.

(51) Int. Cl. G06F 17/24

(52) U.S. Cl. CPC G06F 17/248
USPC 715/256

(57) ABSTRACT

Systems and methods of document creation are disclosed. The disclosed embodiments may receive user input to generate an electronic interview to be presented to an interviewee, including a query to be presented to the interviewee and a corresponding interview input component configured to receive electronic interview data from the interviewee pertaining to the query. A mapping is established for the interview input component to map to an element of a template of a document creation system. The electronic interview data is received and delivered to the document creation system. A document is created that includes as content the electronic interview data.

### RELATED APPLICATIONS

This application claims priority to U.S. Provisional Patent Application No. 61/824,890, titled SYSTEMS AND METHODS FOR CREATING A DOCUMENT, filed May 17, 2013, which is hereby incorporated herein by reference in its entirety.

### COPYRIGHT NOTICE

© 2014 EvolveMed. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

The present disclosure relates to systems and methods for creating documents.

### BRIEF DESCRIPTION OF THE DRAWINGS

The present disclosure may best be understood by reference to the following description taken in conjunction with the accompanying drawing figures, in which like parts are referred to by like numerals.

FIG. 1A is a block diagram of a document creation system, according to one embodiment of the present disclosure.

FIG. 1B is a block diagram of a document creation system, according to another embodiment.

FIG. 2 is a block diagram of an interview subsystem of a document creation system, according to one embodiment.

FIGS. 3A-3D illustrate a graphical user interface of an interview creator/editor of an interview subsystem of a document creation system, according to one embodiment.

FIGS. 4A-4C illustrate a graphical user interface of an interview portal of an interview subsystem of a document creation system, according to one embodiment.

FIG. 5 illustrates a graphical user interface of an interview workflow manager of an interview subsystem of a document creation system, according to one embodiment.

FIG. 6 is a block diagram of an input subsystem of a document creation system, according to one embodiment.

FIGS. 7A and 7B illustrate a graphical user interface of an input subsystem of a document creation system, according to one embodiment.

FIG. 8 is a flow diagram of a method of document creation, according to one embodiment.

FIG. 9 is a flow diagram of a method of document creation, according to another embodiment.

FIG. 10 illustrates use cases for a document creation system to create medical records, according to one embodiment of the present disclosure.

FIG. 11 is a block diagram of a system for creating a document, according to one embodiment of the present disclosure.

FIG. 12 is a block diagram of a document, according to one embodiment of the present disclosure.

FIG. 13 illustrates a patient interaction report (output document) generated by a creation and management system, according to one embodiment of the present disclosure.

### DETAILED DESCRIPTION OF PREFERRED EMBODIMENTS

Documentation is an important aspect of a wide variety of roles, services, industries, sectors, occupations, professions, and the like. Documentation, or the act of documenting, may include creating or generating a document or other record or work product, compiling evidence, or imparting knowledge. In some instances, documentation forms a significant aspect of a given role or function, for example to comply with regulations, to codify standard operating procedures (SOPs), to compile evidence, and/or to convey information.

A familiar industry in which documentation is of significance is healthcare. Although the major role of healthcare professionals is to provide care to patients, documentation of the care provided forms a significant aspect of what medical professionals are doing day to day.

Creating and editing, or otherwise generating documentation can be tedious and time consuming. Traditionally rudimentary documentation could be generated by free-form handwriting. Modernly, documentation may be generated electronically by computer and strides are being made to save time and effort expended toward documentation. Computer documentation systems generally provide a methodology for a user to create a record via typing and/or mouse clicks to speed up completion of a document. However, typing and/or mouse clicks provide a limited choice of input methods, and with significant limitations. Typing and formatting by typing to provide functional and easily digestible document content can be more tedious and time consuming than handwriting. Clicking on predetermined choices can result in a document losing nuance from and personalization by the document creator.

As an example, medical documentation has involved dictation and transcription as a way to reduce both the tedium and burden of documentation for some medical practitioners. The nuance included with dictation is lost where only clicking or typing is available.

Documentation can become more time consuming and tedious as more parties become involved in the process, particularly when regulations or other constraints dictate and/or limit methodologies of transferring information (e.g., security requirements, protocols, etc.).

As an example, in healthcare, certain specialty practitioners can accept a patient after a referring physician provides appropriate information about the patient. Traditionally the transfer of information occurs during a phone call between the referring physician and the specialty physician because privacy regulations may prohibit communication between agents of the physicians, such as office staff. Because these referral phone calls may be considered entirely administrative rather than medical care provided to a patient, generally neither the referring physician nor the specialty physician is compensated for the time spent on such phone calls. Accordingly, referral phone calls can understandably be challenging to arrange, often involving multiple voice messages to set up and eventually occurring after office hours when patients are not being seen.

Present electronic forms of communication are inadequate to transfer the desired information between a referring physician and a specialty physician. The physicians may have different styles of documentation. The specialty physician may need or desire information that the referring physician may not consider significant to convey.

A further burden on the documentation process is that once the specialty physician receives the desired patient data, that information may need to be entered into the specialty physician's computer documentation system. The data entry process to input the information into the system can be time consuming and prone to error.

An improved document creation system, enabling multiple methods of input and entry creation to generate document content and improve efficiency is desirable. Customization of the document creation process is desirable.

Disclosed herein are systems and methods for creating a document that include multiple methods of input and entry creation to generate document content and improve efficiency.

In one embodiment, a document creation system may be configured as a record creation system for creating a medical record. In this configuration, the document creation system may capture physician input during a patient encounter with suitable nuance and detail as desired. As will be described, the document creation and management system enables information regarding a patient to be captured in a manner to minimize unnecessary sacrifice of a physician's valuable time and/or minimize impairment of the integrity of the patient encounter, for example, by obligating the physician to repeatedly disengage from communication with the patient to enter information, or requiring the physician to spend additional time after-hours to complete a medical record.

In one embodiment, the information regarding the patient may be gathered from someone other than the document creator (e.g., the physician). An interview subsystem of a document creation system may enable a user to collect information from a third party (e.g., a non-user of the document creation system) by enabling the user to create and publish interviews. The interviews may be published, for example, to the Internet, such that a non-user can access and complete an interview. The interview subsystem may automatically map collected data for possible insertion into a document. Thus, the interview subsystem may be an additional way to input data into the document creation system. The interview subsystem may also extend the reach of the document creation system to non-users.

An example application of the disclosed embodiments may involve a specialty physician (e.g., a user of the document creation system) who may desire to collect certain information from referring physicians. Rather than arrange a phone call to exchange the information, the specialty physician can use the disclosed embodiments to create an interview. The interview queries and/or input fields can be mapped to an element of a template of the document creation system. (The mapping may also correspond to a standard field (or mapping) of an external system, such as an electronic medical record (EMR) system for eventually porting a document to such external system.) The interview is published and the referring physician can access a portal to complete the published interview. By the referring physician completing the published interview, rather than making a phone call, the information collected from the referring physician is already input into the document creation system of the specialty physician. The mapping may enable automatically inserting the information into a document of the specialty physician. In another embodiment, the mapping may enable the specialty physician to optionally (e.g., upon selection of the information, acceptance of the information, or the like) insert the information into a document (e.g., a medical document, chart, record or the like) being created by the specialty physician.

In the field of medical records, freeform dictation is often preferred for effective and complete documentation. The interview subsystem and/or methods may include a record input option (e.g., dictation input option) allowing a physician to reap at least some of the benefits of freeform dictation. Recorded input may be automatically sent for processing, such as transcription of the recorded audio to text.

The disclosed embodiments may also make historical information of the patient readily available for input into a document. The physician may be presented with historical information about the patient (e.g., a vital sign reading from the previous visit) for comparison and/or insertion into a document.

Although the present disclosure provides a detailed description of a particular embodiment in the context of medical records, a person having ordinary skill in the art will appreciate that the invention is not so limited. The disclosure contemplates creation of records or documents in any field of endeavor involving document and/or information creation and/or management, including but not limited to law, architecture, engineering, software development, and/or other fields. The principles, features, systems, and methods discussed are merely indicative of exemplary applications and may be applied to other technical fields outside of the healthcare/medical field.

The subject matter may be described herein in terms of various functional components and processing steps. It should be appreciated that such components and steps may be implemented as any number of hardware or software components or combination thereof configured to perform the specified functions. For example, an exemplary embodiment may employ various graphical user interfaces, software components, and database functionality.

For the sake of brevity, conventional techniques for computing, data entry, data storage, networking, speech recognition, and/or the like may not be described in detail herein. Furthermore, the connecting lines shown in various figures contained herein are intended to represent exemplary functional relationships and/or communicative, logical, or physical couplings between various elements. As will be appreciated, however, many alternative or additional functional relationships or physical connections may be present in a practical implementation of a document creation and management system or method.

The present disclosure also relates generally to information management, and to methods and systems for creating documents via predefined and/or customizable input components, tools, and techniques. Various example embodiments provide systems and processes for creating a document in a particular technical field, for example, via input through customized clicking, touching, talking, and/or typing. The disclosed systems and methods may also include managing created documents, including porting created documents to an external system.

Moreover, additional exemplary embodiments may provide systems and processes for creating a medical record, for example via input through customized clicking, touching, talking, and/or typing. The disclosed systems and methods may be further configured to port such medical records to an external system, such as an electronic medical record (EMR) system. A document creation system according to the present disclosure may be any system configured to facilitate data input to create a document.

A document, as the term is used herein, may refer to any collection of data or information having a defined organization. The data of a document may include content and the organization of the content may be defined by formatting rules. Although a document may encompass data or information printed on paper, the term document is broader and encompasses any association of stored content, including content stored electronically or stored in a computer readable storage medium, with formatting rules specifying the presentation of the content. A document may further include other components such as headers, footers, disclaimers, tracking information, author information, security settings, and processing rules, some of which may be stored as entries and some of which may be stored in an alternative manner.

According to one embodiment of the present disclosure, a document may be preliminary or finalized. A preliminary document may be considered a work in progress, and can be modified, edited, changed, and the like. Content may be added and formatting of the content may be changed. In one embodiment, a finalized document cannot be modified, edited, changed, or the like, and remains in a permanently fixed state. In other embodiments, a finalized document may need to be unfinalized before changes can be made.

An output document is a form of document in which the content of a document is presented according to the associated formatting rules—i.e., a presentation of a document. An output document may be presented in any suitable format, including paper or electronic formats. An output document may be presented for visual inspection by a user. An output document may be presented to an external system (e.g., an EMR system) for incorporation into such external system. An output document may be preliminary or finalized. For non-visual data contained in a document, an output document may present an icon or other indication that the non-visual data is embedded in the document. The icon may be positioned in the document according to the formatting rules and structure of the document.

The content of a document, according to the present disclosure, may be made up of one or more discrete entries (e.g., entries that are discretely stored relative to other entries). The term “entry” as used herein refers to any data, including but not limited to text, image data, audio data, and/or video data, that can be entered into or used to create the contents of a document. An entry may include one or more other entries. For example, an entry may include both text and an audio component. The text may be composed as a discrete entry and the audio may be composed as a discrete entry, and then the two entries may be combined in a new entry. In one embodiment, the text may be a preconfigured label or description of the audio entry. In another embodiment, the text may be a transcription of the audio entry. As another example, an entry may include both text and an image. The text may be composed as a discrete entry and the image may be composed as a discrete entry, and then the two entries may be combined to form a new entry. An entry may also include another document. In this manner, a document can be inserted into another document.

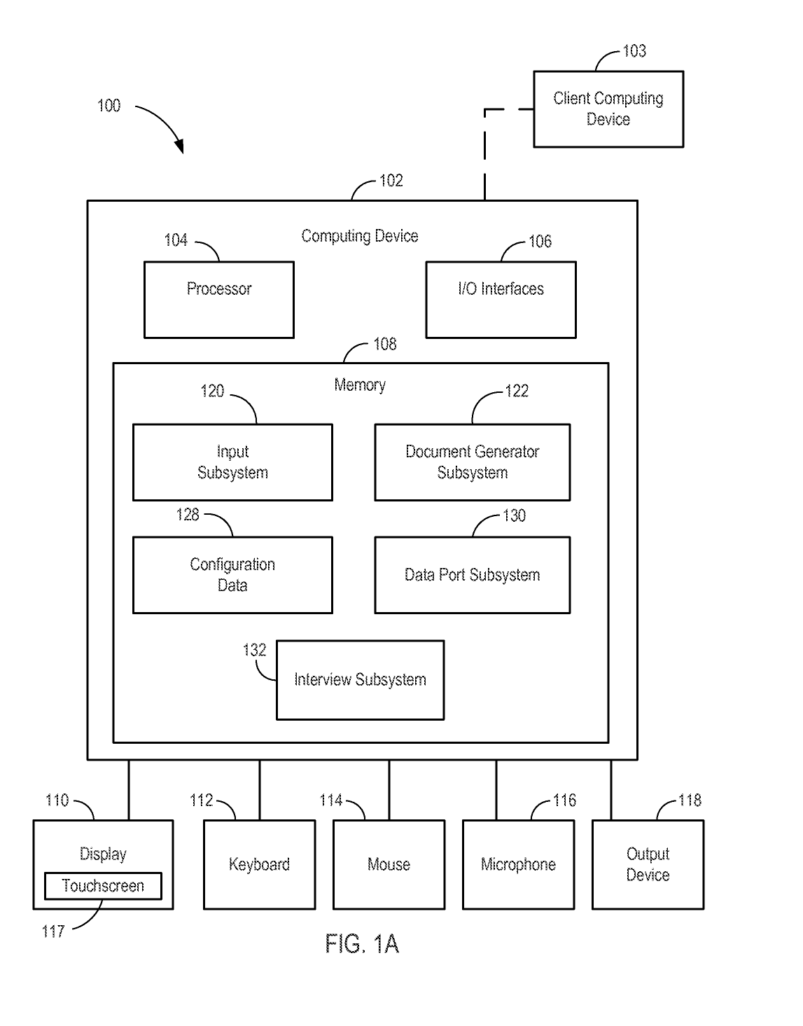

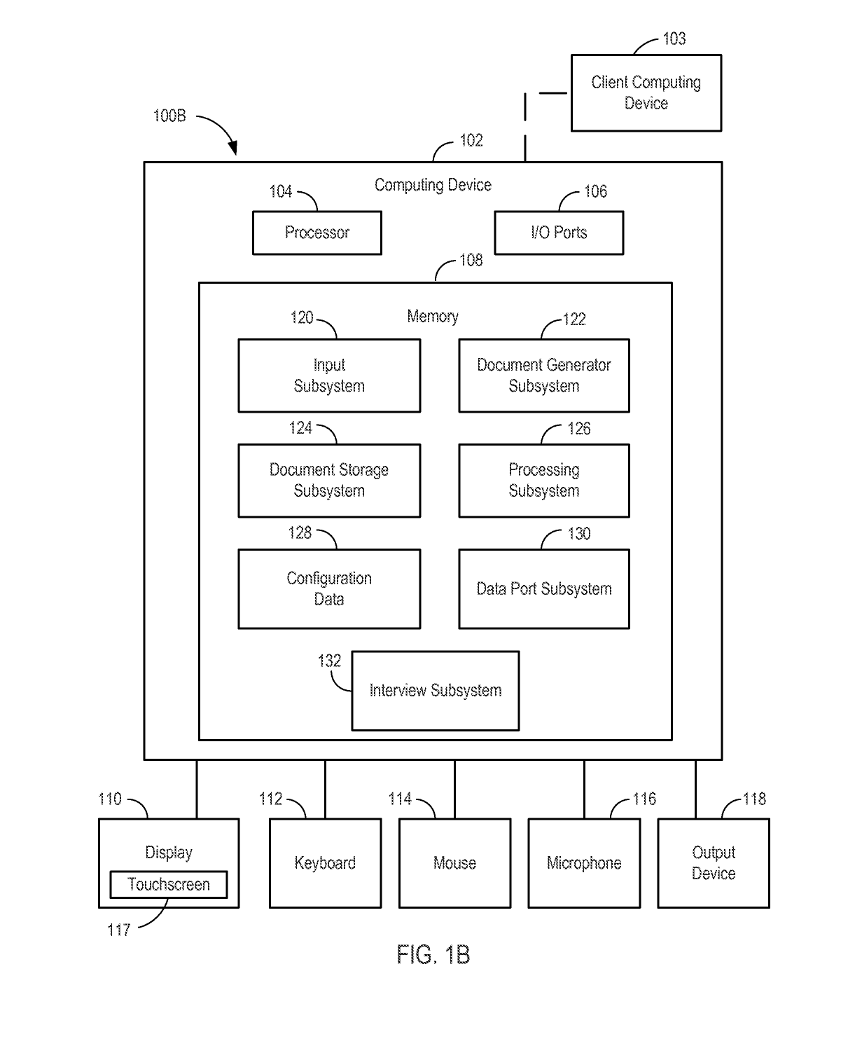

FIG. 1A illustrates a block diagram of a document creation system 100, according to one embodiment of the present disclosure. The system 100 may include a computing device 102 having a processor 104, input and output interfaces 106, a memory 108, a display 110, various input devices including but not limited to a keyboard 112, a mouse 114, a microphone 116, and a touchscreen 117 of the display 110, and an output device 118, such as a printer, a document storage device/system, etc. The document creation system 100 may further include a number of components, including an input subsystem 120, a document generator subsystem 122, configuration data 128, a data port subsystem 130, and an interview subsystem 132. In the illustrated embodiment, these components may be modules stored in the memory 108. In one embodiment, one or more of these and other components (the input subsystem 120 and the document generator subsystem 122, a document storage subsystem, etc.), or combinations thereof, may be implemented as document creation software. In another embodiment, one or more of these components may be implemented in hardware. In still another embodiment, one or more of these components may be implemented in hardware and software. In still another embodiment, one or more of these components may be external to the document creation system 100.

In the illustrated embodiment, the document creation system 100 may include one or more client computing devices 103 coupled to the computing device 102, for example, via a network. The client computing device 103 may similarly include input and output devices and may enable remote presentation of user interfaces of the document creation system 100.

In other embodiments, the computing device 102 may be a personal computer, a laptop, a tablet, or similar stand-alone portable computing device that allows interview creation, delivery, and response processing. In other words, an interviewer may generate an electronic interview on the computing device 102, and interviewee may access the electronic interview on the computing device 102, and documents may be generated on the computing device 102. As can be appreciated, a variety of system configurations are possible. An interview creation computing device may be the client computing device 103. An interview creation computing device may be the central computing device 102. In other embodiments, the interview creation computing device may be the same as an interviewee computing device, which may be the client device 103 or the computing device 102. Similarly, the interviewee computing device may be the client computing device 103. In other embodiments, the interviewee computing device may be the central computing device 102.

The input subsystem 120 may be configured to facilitate input of data to create a document. In the illustrated embodiment, the input subsystem 120 may comprise one or more software modules configured to present a set of user interfaces and/or input controls for receiving input in a variety of ways. For example, the input subsystem 120 may comprise a user interface providing a click input control interface configured to receive data input via a mouse click, a touch input control configured to receive data input via touch, a type input interface configured to receive data input via keyboard strokes, a recorder input control configured to receive data input via a microphone, test and/or diagnostic equipment, and/or monitoring equipment (e.g., patient monitoring equipment), and so on. The user interface(s) of the input subsystem 120 may be presented on the client computing device 103, for example as a client-server application. The input subsystem 120 may also be configured to receive input of data received via the interview subsystem 132 to compose discrete entries to create the content of a document.

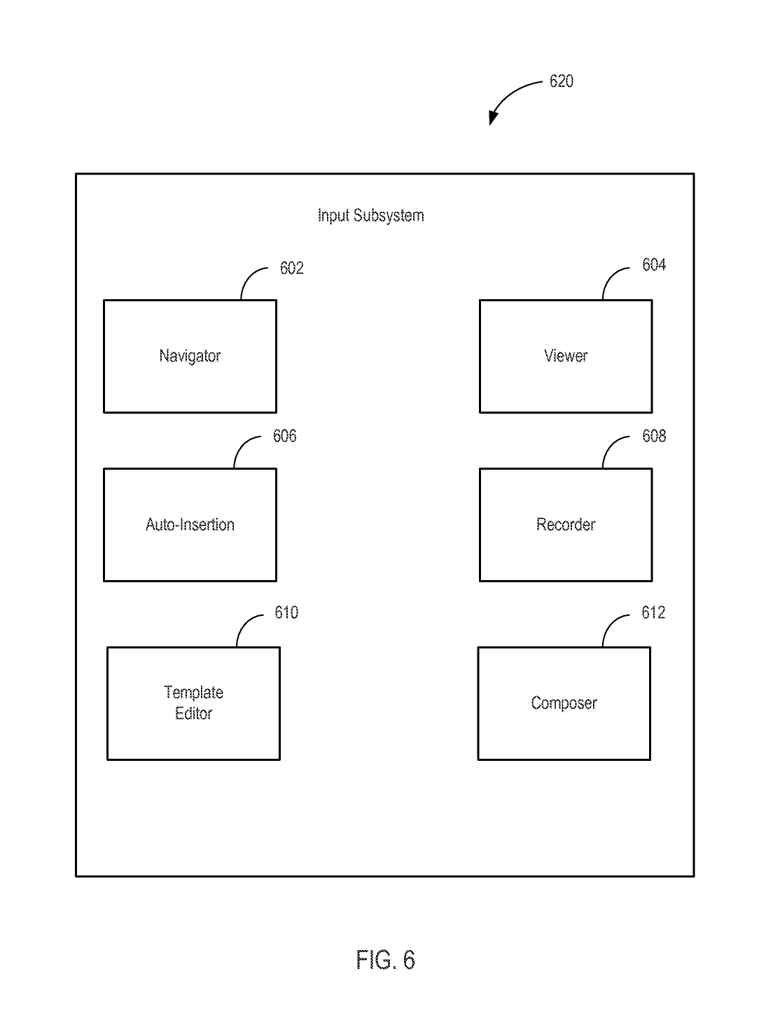

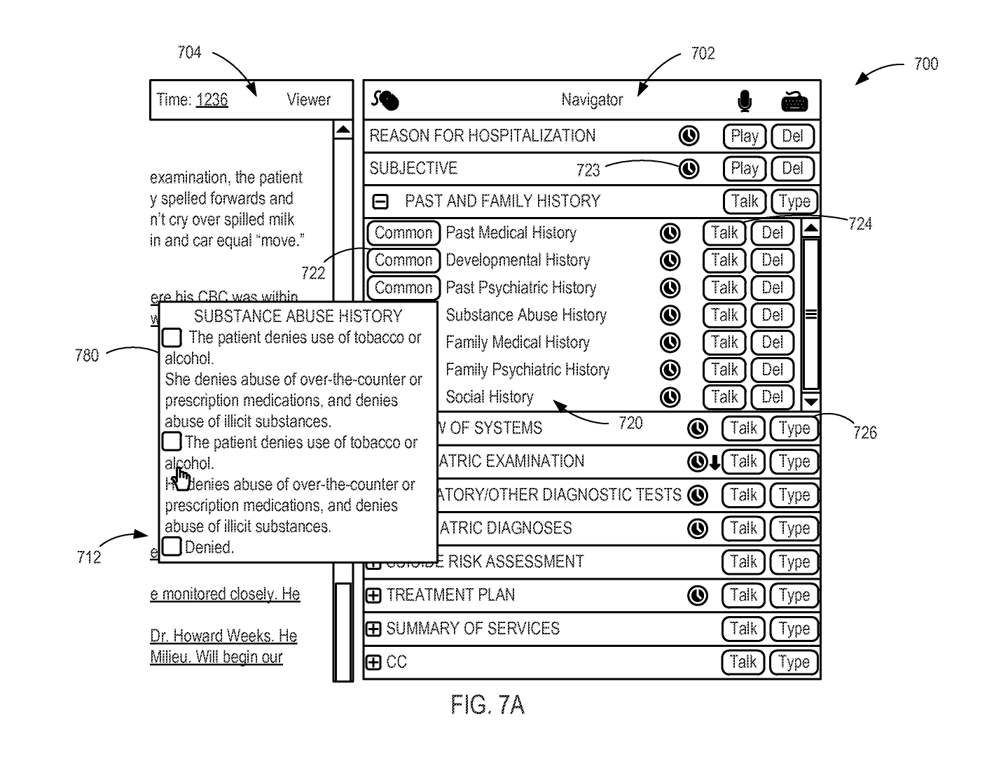

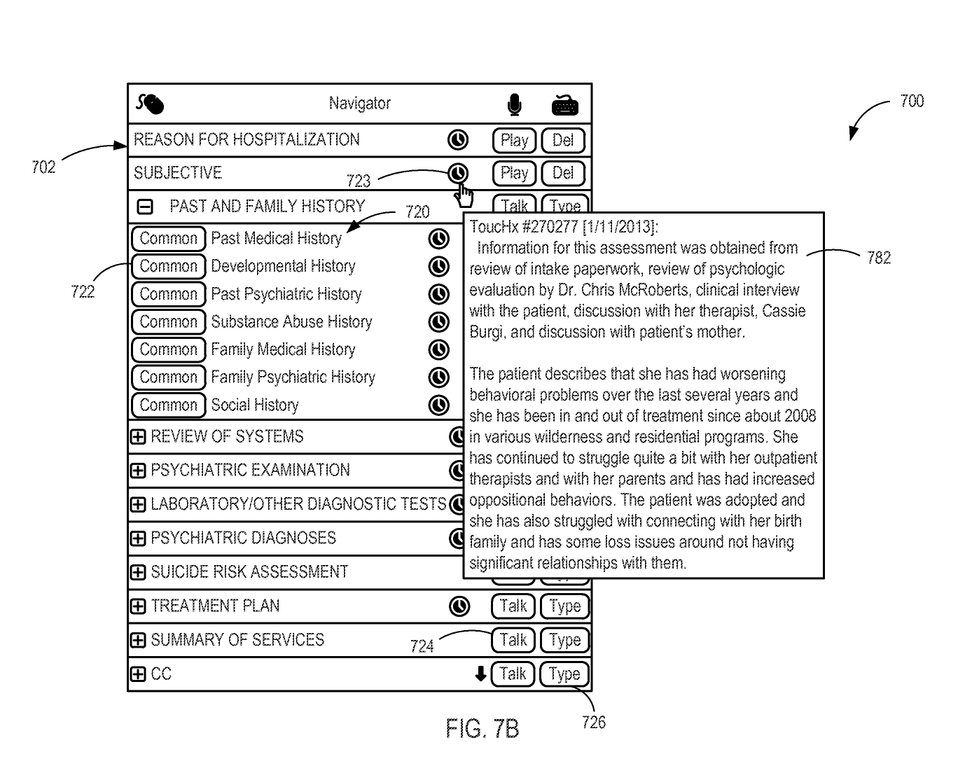

The input subsystem 120 is shown in greater detail in FIG. 6, and a user interface of an input subsystem 120, according to one embodiment, is illustrated in FIGS. 7A and 7B, and described more fully below with reference to these figures.

The document generator subsystem 122 is configured to create a document using at least a portion of the input received via the input subsystem 120. In particular, the document generator subsystem 122 uses entries composed by the input subsystem 120 to generate a document. The document generator subsystem 122 may also perform one or more operations to produce an output document (i.e., the content of a document presented according to associated formatting rules). The document generator subsystem 122 may also use entries composed by the interview subsystem 132 to generate a document.

The configuration data 128 may comprise user profile information, such as user login and password information. The configuration data 128 may store data to administer the system. In another embodiment, the configuration data 128 may include templates, formatting rules, and the like that may affect a document's formatting, arrangement, structure and the like. The templates may be customizable according to preferences of a given user. A template may be associated with a profile of a given user who customized the template.

The data port subsystem 130 may provide data communication services between various other components of the document creation system 100. For example, the data port subsystem 130 may receive composed entries from the input subsystem 120 and communicate the entries to the document generator subsystem 122 to be incorporated into the content of a document. Similarly, the data port subsystem 130 may communicate formatting rules for that document from the input subsystem 120 to the document generator subsystem 122. The data port subsystem 130 may also communicate the document to a document storage subsystem for storage of the document. The data port subsystem 130 may also communicate the document and/or entries of the document to a processing subsystem and in turn receive the document back from the processing subsystem after processing. The data port subsystem 130 may also facilitate exporting a created document to an external system, such as an external document system (e.g., an electronic medical record (EMR) system). The external document system may be operated and/or maintained by a third party.

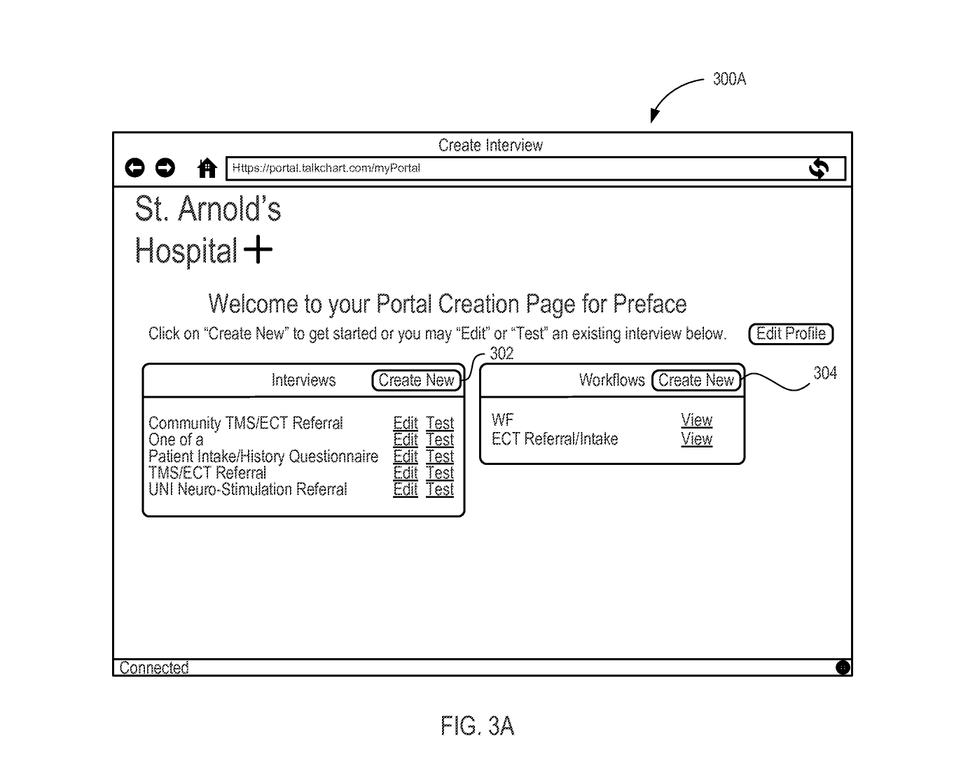

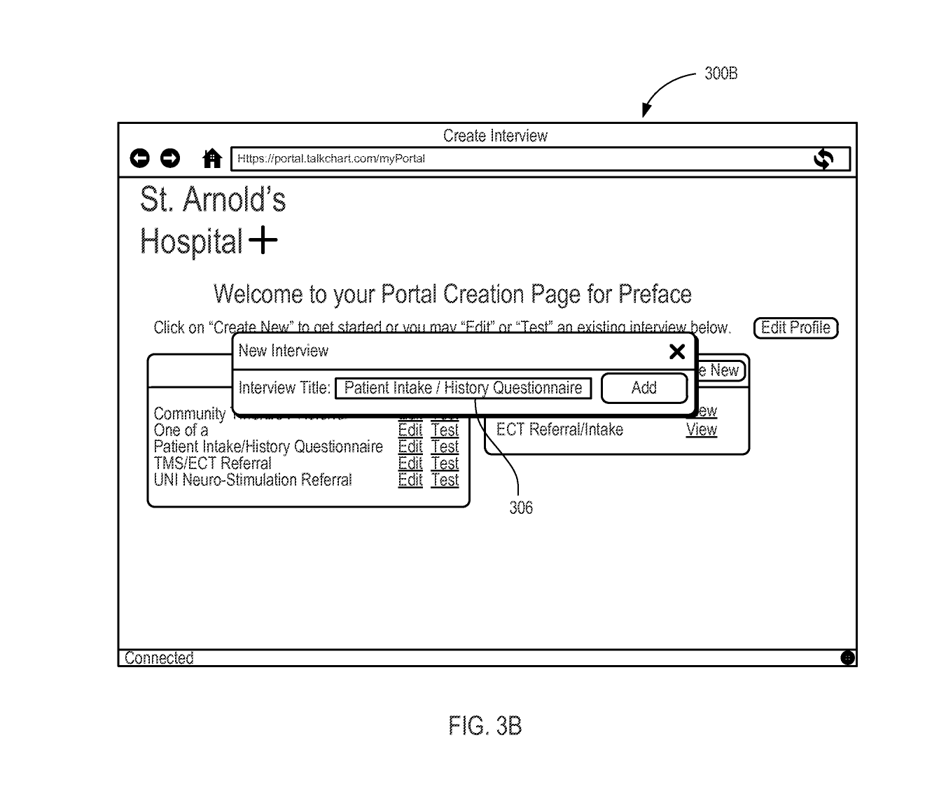

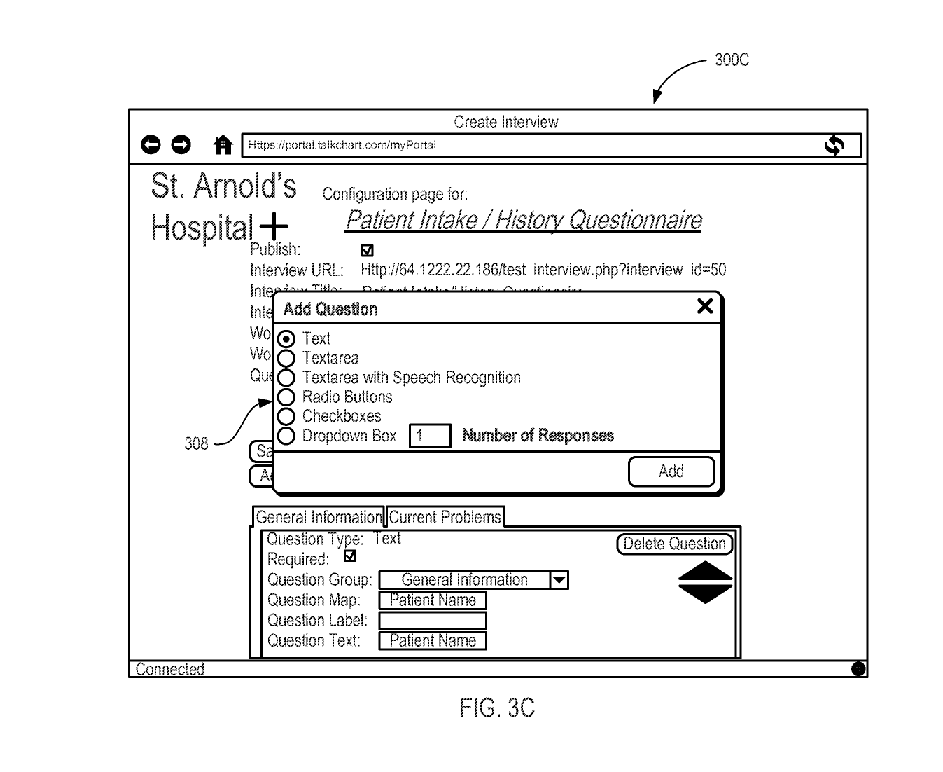

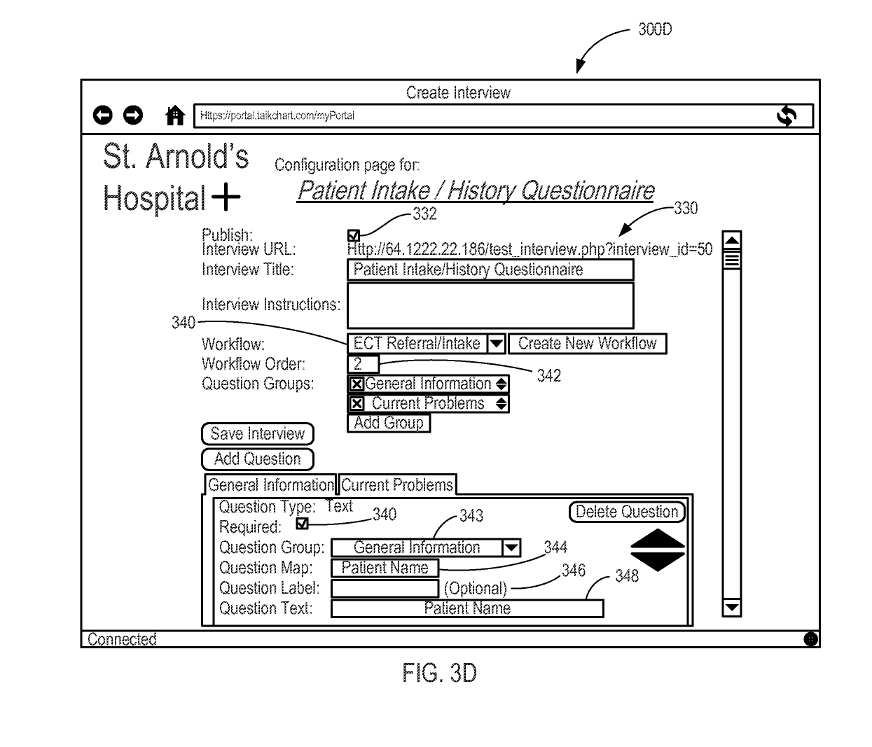

The interview subsystem 132 may enable a user to create and/or edit an electronic interview to provide (e.g., publish) for access by a third party. For example, a published interview may allow a third party, such as an individual without typical access rights to the document creation system, to input information, via the electronic interview, into the document creation system. A creator of a document (e.g., a physician creating/editing a medical record) can generate a customized interview configured to collect desired information from a third party (e.g., an interviewee). The electronic interview can be customized to provide labels and input fields suitable to collect the desired information from an interviewee in an efficient and straightforward manner. Creation and/or customization of an electronic interview is illustrated in FIGS. 3A-3D and described below with reference to the same. The creator of the document (e.g., an interviewer) can publish the interview for access by the interviewee. Publishing an interview may include posting the interview to the Internet and generating a unique URL that can be communicated to an interviewee. In one embodiment, the interview may be customized according to input received, for example, via a client computing device 103.

The desired information may be collected as electronic interview data received through a published interview. For example, the published electronic interview may be accessed by an interviewee via the client computing device 103. Collection of electronic interview data through a published electronic interview enables the interview subsystem 132 to directly integrate the collected interview input data into the document creation system 100. For example, the interview input data may be presented as preconfigured data for insertion into a document by actuation of, for example, an input component of a graphical user interface of the input subsystem 120. As another example, the interview input data may be automatically inserted into a document, such as through the document generator subsystem 122.

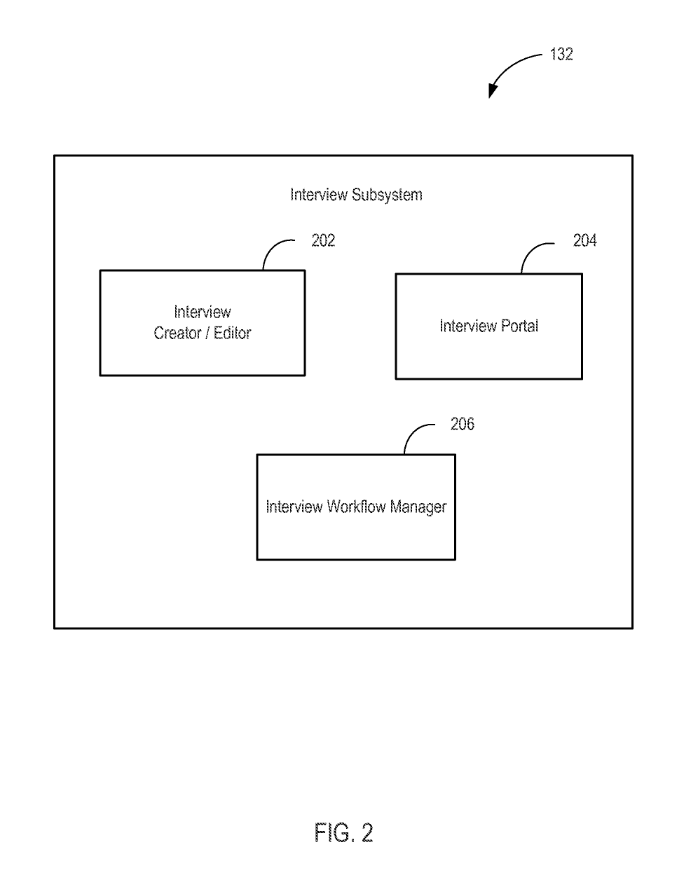

The interview subsystem 132 is shown in greater detail in FIG. 2, and a user interface of an interview subsystem 132, according to one embodiment, is illustrated in FIGS. 3A-3D, and described more fully below with reference to these figures.

Additional description of a document creation system 100, including additional description and examples of an input subsystem 120, a document generator subsystem 122, configuration data 128, and a data port subsystem 130, is provided in U.S. patent application Ser. No. 12/891,740, filed Sep. 27, 2010, titled DOCUMENT CREATION AND MANAGEMENT SYSTEMS AND METHODS, which is hereby incorporated herein by reference in its entirety. As can be appreciated, the interview subsystem 132 may be integrated with or otherwise provide a point of access (e.g., an external front end) for a variety of document creation systems, including the embodiments of document creation and management systems disclosed in the above identified application.

FIG. 1B illustrates a block diagram of another embodiment of a document creation system 100B. The system 100B may include one or more of the same components as system 100, as described above with reference to FIG. 1A, and may further include additional components. Specifically, the system 100B of FIG. 1B further includes a document storage subsystem 124 and a processing subsystem 126.

The document storage subsystem 124 may be configured to store documents. The document storage subsystem 124 may store discrete document entries and store documents as an association of discretely stored entries. In one embodiment, the document storage subsystem 124 may be implemented as a relational database. As will be appreciated, however, the document storage subsystem 124 may be implemented in any manner suitable for storing discrete entries and associating groups of entries that form the content of a document. Moreover, as can be appreciated, in another embodiment, the document storage subsystem 124 may be embodied in a separate device. In one embodiment the document storage subsystem may comprise an independent document storage system (e.g., an electronic medical record (EMR) system). In one embodiment, the document storage subsystem may also include document templates, to guide user input to generate documents. The templates may provide, among other things, formatting rules and processing rules for the document, which may affect a document's formatting, arrangement, and structure. The templates may be defined by user interaction with the input subsystem 120. Alternatively, the templates may be predefined externally and loaded into the system 1008. The templates may specify the formatting of a document (e.g., the arrangement of entries within the document, margins, page orientation, type face, bold, underlining, italics, etc.). The templates may also specify the formatting of particular entries (e.g., type face, bold, underlining, italics, etc.).

The processing subsystem 126 may include various functions for processing documents and/or entries of documents, including but not limited to formatting, merging, parsing, transcribing (e.g., transcription of dictated audio input), translating text from/into a foreign language, editing, spell-checking, encrypting, summarizing, and/or the like. For example, the processing subsystem 126 may include a speech-recognition component configured to facilitate speech-to-text machine transcription of dictation audio input (also referred to herein as a “dictation snippet,” to distinguish from non-dictated audio input). The processing subsystem 126 may also include an optical character recognition (OCR) component to, for example, provide electronic translation of image input containing handwritten, typewritten or printed text into machine-encoded text. The processing subsystem 126 may also include a machine translation component to translate text from one language to another. The processing subsystem 126 may further include a spelling and/or grammar checker. The processing subsystem may further include an encryption component to provide encryption of sensitive information in an entry. As can be appreciated, some processing functions may be performed internally, such that the processing subsystem 126 may be a part of the document creation and management system 1008, while some functions may be better performed by a third party, external to the document creation and management subsystem. Accordingly, the processing subsystem 126 may be embodied in a separate device.

FIG. 2 is a block diagram of an interview subsystem 132 of a document creation system 100, according to one embodiment. The interview subsystem 132 may include an interview creator/editor 202, an interview portal 204, and an interview workflow manager 206. As briefly described above, the interview subsystem 132 may be configured to enable a user (e.g., an interviewer user) of the document creation system 100 to generate interviews to collect electronic interview data from another individual for possible insertion into a document.

The interview creator/editor 202 may provide a user interface to an interviewer (e.g., a user of the document creation system 100) to enable the interviewer to create/edit a customized interview. FIGS. 3A-3D illustrate a user interface 300A, 300B, 300C, and 300D (collectively 300) of an interview creator/editor 202 of an interview subsystem 132 of a document creation system 100, according to one embodiment.

FIG. 3A illustrates a user interface 300A of the interview creator/editor 202 presenting a list of currently available (e.g., previously created) interviews and a list of workflows. A user may select an existing interview and/or workflow and edit or test such existing interview. A “create new” interview button 302 or similar input component may also present an option to create a new interview. A “create new” workflow button 304 or similar input component may also present an option to create a new workflow.

During a process of creating an interview, input may be provided by a user and received through the user interface. The input provided by the user may provide a title for the interview, define queries (e.g., query text and/or audio), designate or otherwise provide input components for each query, provide a query label, specify whether a query is required or optional, and provide a query mapping (to map the electronic interview data received through the input component to a mapping of a document template of the document creation system). A query may be phrased in the form of a question (e.g., “What is the patient's name?”) or may be phrased in the form of a statement specifying or describing the information desired (e.g., “Patient Name”).

FIG. 3B illustrates the user interface 300B presenting an input component 306 to enable a user to input a name or label for a new interview. The input component 306 may be a text field, a text area, or the like.

FIG. 3C illustrates the user interface 300C presenting one or more input components 308 to receive information designating a query input component to correspond with a query of the new interview being created. In the illustrated embodiment, the input components 308 may be radio buttons.

FIG. 3D illustrates the user interface 300D after one or more queries of the interview have been defined. The interview subsystem 132, and in particular the interview creator/editor 202, may generate a unique link 330 (e.g., a URL) by which the interview can be accessed by an interviewee. The interview URL can be communicated to a desired recipient (e.g., a potential interviewee), such as via email, text message, or other electronic communication. A publish input component 332 may publish the interview to the Internet, an intranet, an internal network, or otherwise to provide the interviewee access to the electronic interview. Upon selection or other manipulation of the publish input component 332, the interview subsystem may post the electronic interview to an accessible location (e.g., publicly accessible directory from the Internet). The interview subsystem may also deliver the unique link 330 to an interviewee. The interview subsystem 132 may further include an interview deliverer subsystem to facilitate delivery of the URL to a desired recipient. The interview deliverer subsystem may present a user interface to receive input for generating an individual or mass email.

The user interface 300D of FIG. 3D also provides a required input component 340 to designate whether a query is required or optional. A question grouping input component 343 specifies question grouping for a query. A question map input component 344 designates a mapping for a given query. In the illustrated embodiment, the question map input component 344 may be a dropdown box populated with a list of elements from a template of the document creation system. In other embodiments, the question map input component 344 may be one or more different input components (e.g., radio buttons, a text field or area). A question label input component 346 allows the user interviewer to label the question, such as for internal referencing. A question text input component 348 allows the user interviewer to provide the text of the query to be presented to the interviewee.

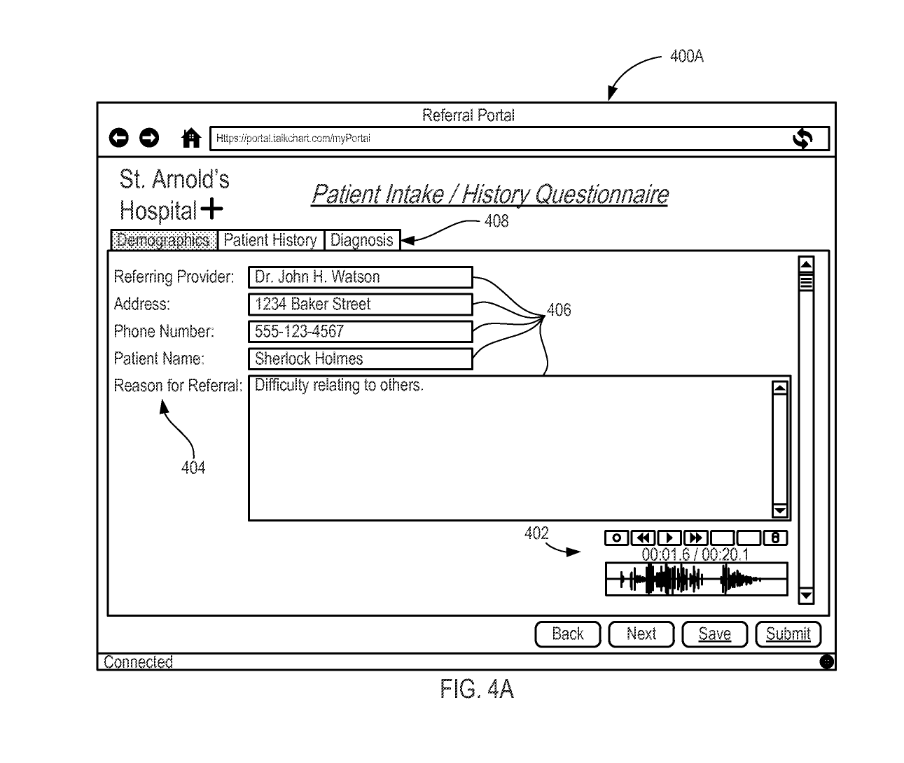

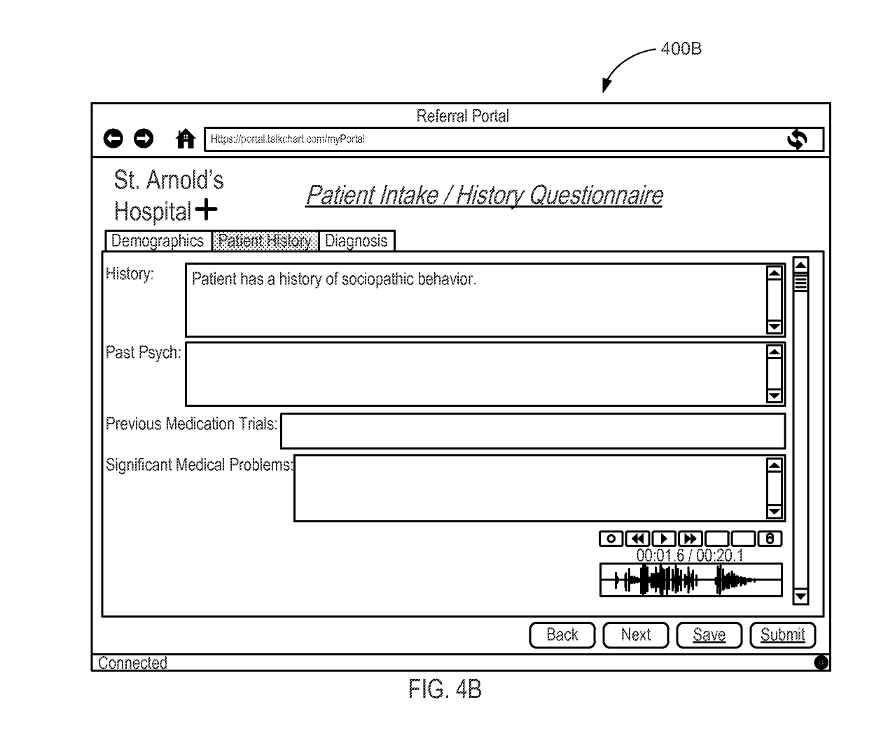

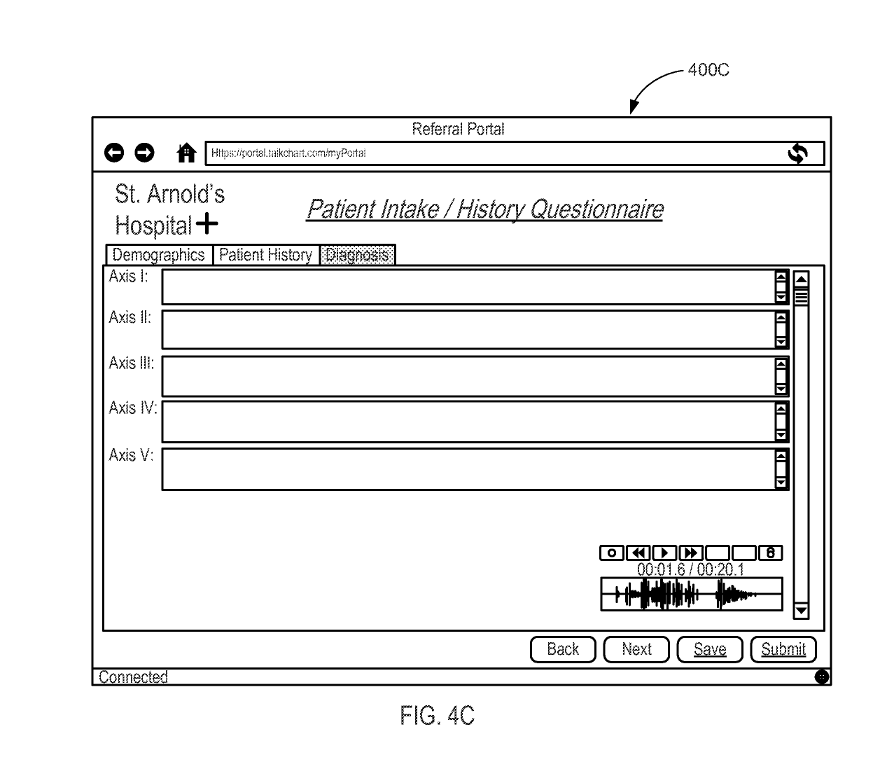

The user interface 300D may also provide a workflow input component 340 for designating a workflow to which the interview is to be associated. A workflow may provide a grouping of interviews. A workflow order input component 342 may enable input to designate a position of an interview within an order of a workflow. The process of gathering information from a third party (e.g., a referring physician) may inherently be a multiple-part process, such that multiple interviews are desirable to obtain additional information. For example, a first interview may collect preliminary information that may be used to determine whether additional information is needed and/or the type of additional information needed. Separating the information collection process into multiple interviews may facilitate use of multiple interviews grouped together to provide a multi-part information collection process. The workflow manager 206 (FIG. 2) enables an interviewer (i.e., a document creator) and/or an agent of the same to manage or otherwise administer the workflow. A user interface 400A, 400B, 400C (collectively 400) of the workflow manager 206 is illustrated in FIGS. 4A-4C and described more fully below with reference to the same.

Moreover, a given interview may be relevant to a number of different workflows. For example, a specialty physician may perform multiple different patient care procedures and may desire to collect different information depending on which procedure is to be performed. The specialty physician may therefore establish multiple workflows—e.g., a workflow for each procedure. Nevertheless, a patient medical history may be information pertinent to any patient medical record. Accordingly, an interview directed to a referring physician to gather information regarding patient history may be relevant to multiple (if not all) of the procedures and, thus, multiple workflows. The workflows may enable a given interview to be used in multiple different workflows.

Referring again to FIG. 2, the interview portal 204 may provide a user interface for an interviewee to respond to queries of a customized interview. FIGS. 4A-4C illustrate a graphical user interface 400A, 400B, 400C (collectively 400) of an interview portal of an interview subsystem of a document creation system, according to one embodiment. Upon creation of an interview, and publishing of an interview, the interview may be accessed by a desired third-party recipient (e.g., an interviewee, such as a referring physician). The interview portal presents a user interface 400 that presents the queries and input components of the interview to collect desired information as electronic interview data. The interview portal 204 may receive the electronic interview data via the user interface 400. The interview portal 204 may also map the received electronic interview data according to the mappings specified during the interview creation. The interview portal 204 may also convert and/or store the received electronic interview data in a format to be used as preconfigured data and/or historical data for use with an input component (e.g., a click input component or touch input component) of the input subsystem of the document creation system. The interview portal 204 may also communicate to and/or exchange electronic interview data with the data port subsystem 130 (see FIG. 1A) to map, convert, and/or store the received electronic data for use as preconfigured data and/or historical data in conjunction with an input component of the input subsystem of the document creation system.

FIG. 4A illustrates the user interface 400A presenting a plurality of queries 404 and corresponding input components 406 of an electronic interview presented by the user interface 400. The queries 404 may be organized according to question groupings (e.g., presented as tabs 408 in the illustrated embodiment). Included among the input components is a recorder input component 402 (or simply “recorder”) configured to record electronic data as a response to an interview query. The recorder 402 may record dictation (spoken audio), allowing an interviewee to dictate a response to an interview query. A recording of dictation may be referred to herein as a dictation snippet. The dictation snippet may be sent to a processing subsystem 126 (see FIG. 1B) for processing, such as transcription into text.

FIG. 4B illustrates the user interface 400B presenting a plurality of queries of a second question grouping (e.g., patient history) and corresponding input components of an interview.

FIG. 4C illustrates the user interface 400C presenting a plurality of queries 404 of a third question grouping (e.g., diagnosis) and corresponding input components 406 of an interview.

Referring again to FIG. 2, the interview workflow manager 206 may provide a user interface for an interviewer (e.g., a user of a document creation system), or agent thereof, to manage the workflow of a series of electronic interviews grouped together as a workflow. As indicated above, multiple electronic interviews can be organized or grouped together into a workflow. The workflow allows for a multi-step information gathering (e.g., interview) process with one or more interviewees (e.g., a patient, a parent of a patient, a referring physician).

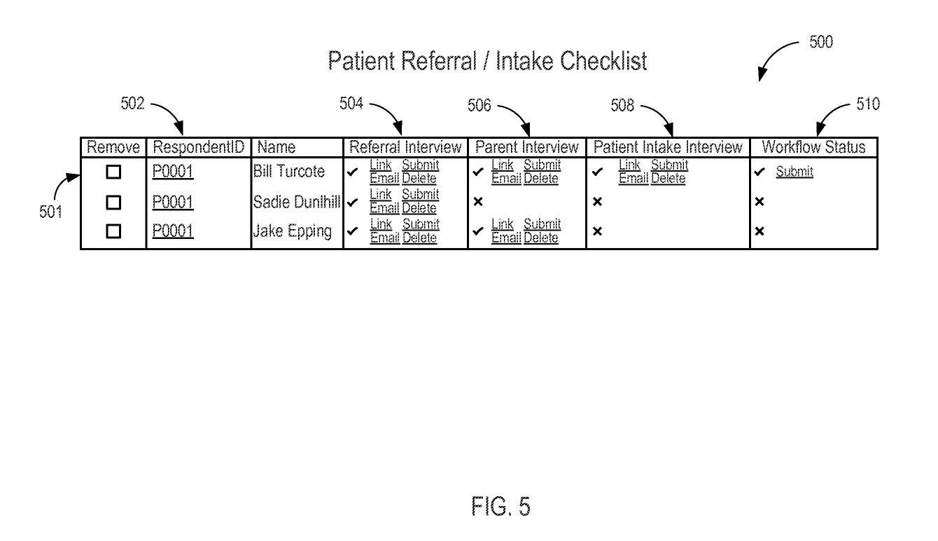

FIG. 5 illustrates a graphical user interface 500 of an interview workflow manager 206 of an interview subsystem 132 of a document creation system 100, according to one embodiment. The user interface 500 may present a graphical display showing progression of a workflow 501 for a given interviewee (or other identifier, such as patient name). In the illustrated embodiment, a respondent ID 502 may be assigned to represent a group of responses. A workflow 501 is shown on the user interface for three respondents (respondent P0001, respondent P0002, respondent P0003). In the illustrated embodiment, the workflow 501 includes three interviews (a referral interview 504, a parent interview 506, and a patient intake interview 508) and the user interface 500 displays progress of which of the three interviews have been completed for each respondent ID (e.g., group of responses). For example, a check mark may indicate the interview is complete for the given respondent ID 502. An “X” may indicate the interview has not been completed. The interviewee (or respondent) may need to complete all three interviews in order to become eligible for registration as a patient with the interviewer (e.g., specialty physician). A final workflow status 510 indicates a status of completion of the workflow (e.g., whether all the interviews in the workflow are completed). If the workflow is completed for a given respondent, an option may be provided to submit the electronic interview data for all the interviews of the workflow, for example to the document creation system for use in creation of documents.

The received electronic interview data may be stored until a workflow is completed, at which point the electronic interview data may be submitted (using a submit option) to a document creation system for use as preconfigured and/or historical data for insertion into a document generated by the document creation system. In another embodiment, the received electronic interview data may be stored until a workflow is completed, at which point the electronic interview data may be automatically delivered to a document creation system, for example, according to a rule configured or defined in the system. The rule may be a business rule and may be configured or defined by a user.

The user interface 500 may also include options to copy the link to the group of responses to the interview, to email the link, to submit the group of responses to the interview, or to delete the group of responses to the interview. The interviewer or authorized agent of the interview may use these options to control the workflow. For example, once the referral interview 504 is completed by a given respondent, the parent interview 506 may be emailed. An invitation or a reminder to complete an interview may be sent to an interviewee. The invitation or reminder can include the unique link corresponding to a set of responses of the interviewee for the interview. Access to a partially completed interview may be protected by a unique temporary respondent ID and a password which may be sent to the interviewee so that the interviewee may have future access to their interview for completion.

In some embodiments, the next interview of a workflow may be automatically transmitted to the interviewee upon completion of an interview. An interviewer may also submit the electronic interview data, for example to the document creation system for use in creation of documents.

The user interface 500 may also enable the ability to access the responses for a given workflow 501 (e.g., by clicking on the respondent ID) or for a particular interview in the workflow (e.g., via the unique link to the interview).

FIG. 6 illustrates a block diagram of an input subsystem 120 (FIG. 1) of one embodiment of a document creation and management system. The input subsystem 120 may comprise a user interface 600 (see, e.g., FIGS. 7A and 7B) and include one or more components to provide one or more user interfaces and/or input controls. The user interfaces and input controls may present data and receive input in a variety of ways. In the illustrated embodiment, the input subsystem 120 may include a navigator component 602, a viewer component 604, an auto-insertion component 606, a recorder input component 608, a composer component 612, and a template editor component 610.

The navigator component 602 (or simply “navigator”) may be configured to provide a guide and structure for collection of input. The navigator component 602 may further be configured to guide, prompt, and/or structure the composition of entries to create the content of a document. For example, the navigator component 602 may provide prompts configured to guide a user's thought process of document creation. In one embodiment, the prompts may be configured to be personalized (or otherwise customized) to a particular user, and substantially mirror that particular user's thought process. The navigator component 602 may be configured based on the configuration data 128 (FIG. 1A). For example, the prompts of the navigator component 602 may be provided by the configuration data. In one embodiment, the configuration data 128 may be a template that is customizable by the user. The template may define formatting rules, including ordering, organizational and structural information for formatting a document. The template may further define entry formatting for individual entries, including but not limited to font, bold, italics, highlighting, and the like. The navigator component 602 may extract formatting information to configure a navigator user interface to guide and structure collection of input to create the content of a document.

The navigator 602 may also use electronic interview data to present input options to the user. For example, electronic interview data may be presented to a user in response to actuation of an input component, as will be described more fully below. The electronic interview data may be mapped to an element of the template. The input component may also be mapped to the same element of the template. Accordingly, the electronic interview data may be made available for insertion into the document upon actuation of the corresponding input component.

The viewer component 604 (or simply “viewer”) may provide a real-time “what-you-see-is-what-you-get” (WYSIWYG) view of an output document (i.e., a presentation of the content, or entries, of a document formatted according to associated formatting rules). In other words, the viewer component 604 may present an output document containing all entries and formatted according to any applicable formatting rules. The viewer component 604 may enable a user to identify gaps in the document and/or visually assess progress toward completion of the document. For data that may not easily be presented visually (e.g., a dictation snippet), the viewer may display an icon to indicate that the data is embedded and available. If the non-visual data is converted to visual data (e.g., a dictation snippet may be transcribed), the viewer may present both the visual data and an icon representing the non-visual data.

The auto-insertion component 606 may automatically compose preconfigured data into an entry of a document, in response to activation or manipulation of one or more input controls. The auto-insertion component 606 may enable a user to quickly and efficiently enter preconfigured data by automatically composing an entry with the preconfigured data, in response to, for example, a mouse click or a touch. Moreover, the preconfigured data may be customized, or otherwise preconfigured, according to an appropriate category of an entry. For example, a click input control may compose preconfigured data into an entry in response to user activation or manipulation. As another example, a touch input control may also compose preconfigured data into an entry in response to user activation or manipulation of the touch input control.

An example of a situation where the auto-insertion component 606 can prove useful is in the medical records context. As part of creating a medical record of an encounter with a patient, a physician, for example, is expected (or required) to record various aspects of the encounter, such as, for example, the status of a series of vital signs. In most patient encounters, many of these vital signs of the patient are normal. Nevertheless, these “normals” (i.e., normal status or result of any particular medical examination) must be recorded and typically a mere entry that the vital is “normal” is not sufficient (e.g., “heart rate is normal” or “allergies normal” would be insufficient). The physician may be expected to describe what “normal” is. For example, an physician may handwrite in the chart that “patient's heart rate is normal between 60 and 100 beats per minute” and that “the patient has no known allergies to medications.” Writing this type of simple yet relatively lengthy statement for each normal, for repeated patient encounters, can be time consuming. The auto-insertion component 606 may enable “normals” or “commons” to be preconfigured and composed into an entry with a click of a mouse or a simple touch. A click input control (and/or touch input control) can be provided for each category or sub-element of an entry in a document (e.g., for each vital sign a physician must check for each patient encounter) and the preconfigured data can be customized for the particular associated category. For a “vital signs” sub-element of the Physical Exam category of entry in a medical record document, data to be auto-inserted by the auto-insertion component could be preconfigured to be the text “patient's heart rate is normal between sixty and one hundred beats per minute.” Similarly, for an “allergies” sub-element of the Past Medical History category of entry in a medical record document, data to be auto-inserted by the auto-insertion component 606 could be preconfigured to be the text “the patient has no known allergies to medications.” In this manner a physician can quickly and efficiently record “normals” in a customized way and according to the physician's personal preference, and pause to provide customized or different data only where a vital sign deviates from normal. As can be appreciated, the preconfigured data of the auto-insertion component 606 can be any form of data, and is not limited to text. For example, an electronic recording of a patient's blood pressure measurement may be auto-inserted as part of an entry for an entry relating to a “vital signs” sub-element of the Physical Exam category.

The recorder input component 608 (or simply “recorder”) may be configured to record data to compose into an entry of a document. The recorder 608 may record dictation (spoken audio), allowing, for example, a doctor to dictate an aspect of a medical record document. A recording of dictation may be referred to herein as a dictation snippet. The recorder 608 may also be configured to record other forms of audio, such as audio of biological processes (e.g., the heartbeat of a fetus, a heart murmur, breathing of pneumonia infected lungs, etc.). The recorder 608 also may be configured to record video, such as for example an ultrasound or an endoscopy. The recorder 608 may also be configured to record biological process monitoring, such as for example monitoring of heart rate, respiratory rate, blood pressure, labor contractions, and the like. The recorder 608 also may be able to record any sort of testing or diagnostic monitoring system output. The recorder also may be able to record global positioning system (GPS) information. In short, the recorder 608 may be configured to record any form of data susceptible to being recorded.

The composer component 612 (or simply “composer”) may be configured to receive and compose typed text into an entry. Upon activation of a type input control, the composer 612 may launch, providing a user an interface into which text can be typed by a user. In one embodiment, the composer 612 may directly enable activation of the recorder 608 to record input to compose into an entry and also enable activation of the auto-insertion component 606 to auto-insert data to compose into an entry. In other words, from the composer component 612 a user may be able to provide data input via various methods, including but not limited to typing text, auto-inserting preconfigured data with a click or touch, and recording data via the recorder 608. In this manner, the composer 612 may provide increased flexibility and options for providing input data to compose into an entry of a document.

In one embodiment, the composer 612 may provide preconfigured data upon launch to guide the generation of typed text. For example, the composer 612 may launch and pre-insert a text sentence with a series of blank spaces to be filled in with typed text. A user may be able to tab between the blank spaces and provide typed, recorded, and/or additional auto-inserted text to fill in the blank. As another example, the composer 612 may launch with a plurality of preconfigured data input options, any of which can be entered, for example, by selecting a particular data input option.

In another embodiment, the composer 612 may further comprise a natural language composer to systematically guide construction of a sentence of text input. The natural language composer may launch with a plurality of preconfigured text input options, any of which can be entered, for example, by selecting the particular option. The text input options may include punctuation controls to simultaneously input the text option and appropriate punctuation to create a flowing, natural, and grammatically correct sentence. The plurality of punctuation controls provide a user flexibility to specify how the text sentence will appear. The configuration data and/or a template may provide the preconfigured text input options, and may allow user customization of what preconfigured text input options are available.

The template editor component 610 (or simply “template editor”) may be configured to enable a user to create a document template to guide creation of documents. The template editor 610 may allow a user to create a new template by adding (creating) and mapping one or more categories of entries. A category may include a label, which can be used as a prompt in the navigator to indicate the type or category of an entry needed to create a document according to the template. In addition, sub-elements of each category can be added and mapped. A category may be considered a top-level heading and a sub-element may define sub-headings under categories. Sub-elements can have an unlimited number of sub-elements. Accordingly, categories and sub-elements may define a simple tree structure with categories as the top level of the tree. Categories can have pertinent findings which may populate a composer window when a user selects the type input control associated with the category. Sub-elements can be found by expanding each category. Sub-elements have a click input control, a record input control, and a type input control.

Categories and sub-elements can be mapped according to group and grading, as in coding, for example. Or they can be mapped to any logical system that allows each category or sub-element to be identified by a secondary permanent label, allowing the category or sub-element label to be handled as merely a label. The mapping may be considered an alias for the category or sub-element.

The sub-elements of a template provide additional options and or structure for composing an entry for a given category. The sub-elements may include findings. The findings defined in a template may specify auto-inserted data for a given category and/or sub-element. The auto-inserted data may include findings (a.k.a., pertinent findings). Findings can be added to the category or sub-element through the template editor. Findings are accessed by selecting the type input control and they exist in the top window of the composer. They may be personalized to each user's thought process to reduce the amount of typing and dictating that is necessary, by creating pre-defined entries that can be clicked on in the composer.

As can be appreciated, the template editor 610 may further enable editing, cloning, renaming, removing, etc. of templates. As previously mentioned, template creation components, such as for example the template editor 610, may be separate from the data input components of the input subsystem 120. For example, the template editor may be accessed via different interfaces and/or paths and/or may require different access permissions. Alternatively, the template editor 610 may be integrated with other components of the input subsystem 120, such that, for example, the template editor 610 can be accessed via the same paths and/or with the same permissions as, for example the navigator, the viewer, and/or the composer and a template could be created or modified concurrently with data input.

FIGS. 7A and 7B illustrate a graphical user interface 700 of an input subsystem 120 of a document creation system 100, according to one embodiment. The user interface 700 may present one or more various components of the input subsystem 120. In the illustrated embodiment, the user interface 700 may provide a navigator 702, a viewer 704, and a composer 712.

The navigator 702 may include one or more prompts 720 to guide a user in the input to be entered to generate the content of a document. The prompts 720 indicate categories and/or sub-elements of categories of input to generate a document. The prompts 720 may be configured to guide or substantially mirror a user's thought process of document creation (e.g., at least the user's thought process with regard to creation of a particular type of document, e.g., a medical record). In one embodiment, the prompts 720 may be configured to be customized and/or personalized to a particular user, and substantially mirror that particular user's thought process. A prompt 720 may be a label, a keyword, a phrase, or the like to indicate information or other data to be input to generate the document. The prompts 720 may correspond to categories and/or sub-elements of categories specified by configuration data. In one embodiment the prompts 720 may correspond to categories and/or sub-elements of categories specified in a template and may be generated and customizable via the template editor.

The navigator 702 may further include one or more input controls. The input controls may correspond to the prompts, such that activation or manipulation of an input control facilitates input of data that will be correlated to the corresponding prompt 720. In the illustrated embodiment, the navigator 702 presents a plurality of input controls for each prompt.

A click input control 722 may activate the auto-insertion component to automatically insert preconfigured data to compose into an entry relating to the associated category or sub-element of a category. In FIG. 7A, the click input control 722 (labeled “Common”) presents preconfigured data, such as common inputs, for the corresponding category or sub-element of a category. The preconfigured data is presented in a pop-up window 780 upon initial actuation (e.g., mouse-over, hover, or click). A further actuation of the click input control 722, for example, to select one of several presented common inputs or click on the input control 722, may compose the preconfigured data into an entry of the document for the corresponding category or sub-element of a category.

The illustrated click input control 722, or another click input control (e.g., similar to the touch history input control 723 described below), may also enable insertion of electronic interview data into the document. Upon actuating the click input control 722, or hovering over the click input control, the user interface may present electronic interview data received via an electronic interview of the interview subsystem 132 (FIG. 1A). The electronic interview data may be mapped to the element of the template to which the click input control 722 corresponds. Subsequent or further manipulation or activation of the click input control 722 may auto-insert the presented electronic interview data into the document

A talk input control 724 (i.e., a record input control) may also be provided as a button. The talk input control 724 may activate a recorder to record data and compose an entry relating to the associated category or sub-element of a category. A type input control 726 may launch the composer enabling a user to input typed text and compose that text into an entry relating to the associated category or sub-element of a category.

In one embodiment, the navigator 702 may also include a play back (or “TalkBack”) control to enable a user to play back recorded audio.

The navigator 702 may also provide a touch history input control 723 that, upon actuation, presents historical data and/or electronic interview data for consideration to compose into an entry. The touch history input control 723 may be associated with an element (e.g., a category or sub-element of a category) in a template and/or the navigator 702. Upon an initial activation (e.g., hovering over or clicking), the touch history input control 723 may display historical data, such as in a pop-up window 782, as shown in FIG. 7B. The historical data may be analogous to preconfigured data of an auto-insertion component (e.g., a click/touch input control 722), although from a different source. The historical data may be obtained from an entry of a previous document created in relation to the same subject (e.g., the same patient) as the document presently being created. The historical data may be obtained from an external system, such as from an electronic medical record (EMR) stored in an EMR system. The historical data may also be obtained from electronic interview data gathered through the interview subsystem 132 during an electronic interview of a third party and related to the same subject (e.g., the same patient). In one embodiment, electronic interview data received by the interview subsystem 132 is imported into the document creation system 100 as historical data. The historical data is mapped to an element of a template. The historical data may also be mapped according to other identifiers, such as a subject ID (e.g., a patient ID), to ensure appropriate historical data is presented by the touch history input control 723. In one embodiment, the historical data may be mapped to a medical record number, which may correspond to an electronic medical record (EMR) number of a corresponding EMR stored in an EMR system.

Further activation of the touch history input control 723 may compose corresponding historical data, including electronic interview data, into an entry of the document for the associated category or sub-element. In this manner, electronic interview data gathered from a third party (interviewee) can be directly integrated into a document being created by a document creation system 100.

In one embodiment, content of a document provided by a third party may be displayed by the viewer as highlighted, or with some indication that the content was contributed by a third party.

In another embodiment, the user interface of the input subsystem may also enable uploading of image files (e.g., X-rays), audio files, video files, and other data files, to be inserted into or otherwise included as content of a document being created.

Additional description of the input subsystem 120 and the elements of a graphical user interface of an input subsystem 120, including a navigator, viewer, auto-insertion component, composer, recorder, and template editor, is provided in U.S. patent application Ser. No. 12/891,740, filed Sep. 27, 2010, titled DOCUMENT CREATION AND MANAGEMENT SYSTEMS AND METHODS, which is referenced above.

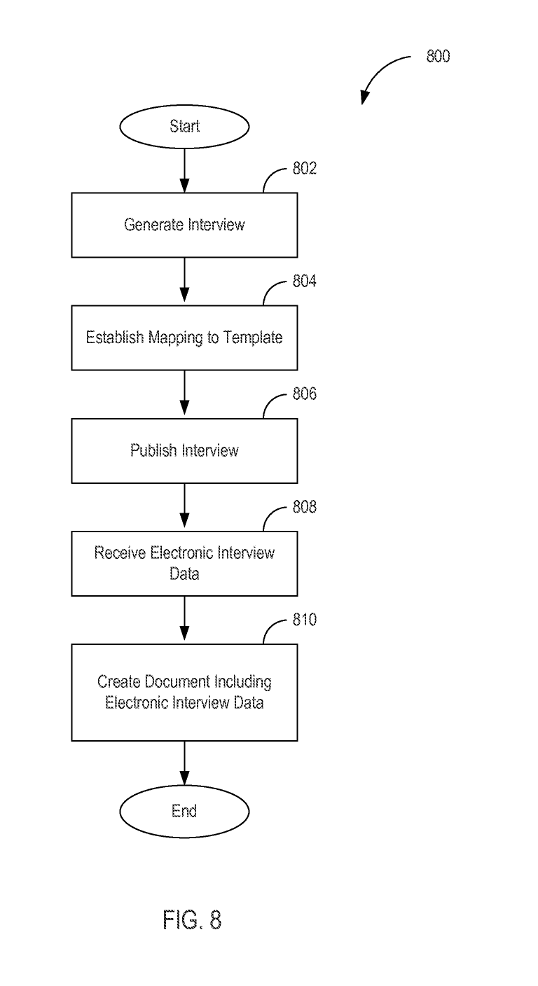

FIG. 8 is a flow diagram of a method 800 of document creation, according to one embodiment. Input is received and used to generate 802 an electronic interview. The input may specify a query to be presented. The input may also specify an input component to receive electronic interview data pertaining to the query. A mapping is established 804 for an input component and/or query of the interview. The mapping may correspond to a mapping of an element of a template of a document creation system. The mapping is assigned to electronic interview data that is received through the interview input component, such that the electronic interview data is associated with the element of the template. The interview is published 806 for access by a third party (e.g., an interviewee) or otherwise made available. Publishing 806 may include posting to the Internet. Publishing 806 may also encompass simply providing interviewee access to the electronic interview. Electronic interview data is received 808, for example, through an interview subsystem and from, for example, an interviewee client computing device. The electronic interview data may be used to create 810 a document. For example, the electronic interview data may be presented and/or selected for insertion as an entry in the document, whereby a document is created 810 including the electronic interview data.

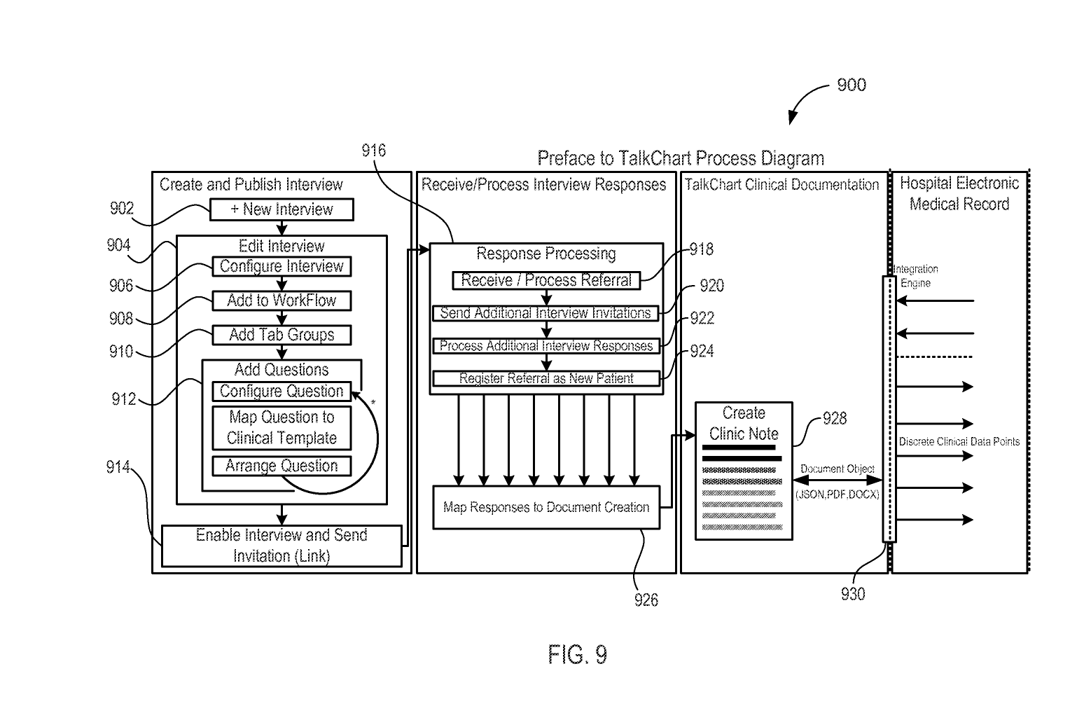

FIG. 9 is a more detailed flow diagram of a method 900 of document creation, according to another embodiment. The method 900 of FIG. 9 may be particular to creation of a medical document, such as a clinic note or an electronic medical record. A new electronic interview may be created 902. The electronic interview may be edited 904, which may include configuring 906 the interview, adding 908 the interview to a workflow, adding 910 the interview to a tab group, and adding 912 questions. The interview is then enabled 914 (e.g., published).

The interview may be intended for a referring physician who completes the interview as part of a specialty physician (interviewer and document creation system user) process to accept referrals (e.g., at the specialty physician's request). The interviewee (referring physician) completes the interview, and the interviewee responses are processed 916. Response processing 916 may include receiving and processing 918 the referral, sending 920 additional interview invitations to the same interviewee or other interviewees, processing 922 additional interview responses, and registering 924 the referral as a new patient. The responses are mapped 926 to clinical data points (elements of a document template) of the document creation system. The responses can then be used to create 928 a document, such as a clinic note. The document can also be integrated and/or translated 930 to an external document system, such as an electronic medical record system of a hospital.

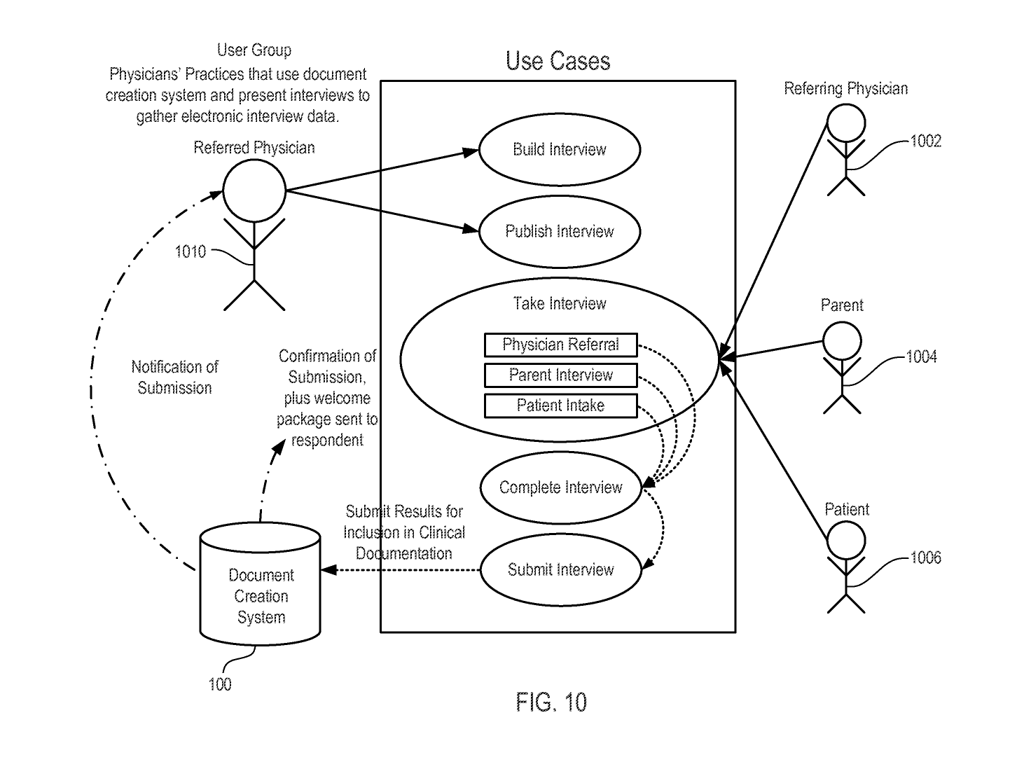

FIG. 10 illustrates example use cases for a document creation system 100 to create medical records, according to one embodiment of the present disclosure. The use cases include gathering electronic interview data from third-party interviewees (e.g., a referring physician 1002, a parent 1004, a patient 1006) for inclusion in a document created by the document creation system 100. The referred physician 1010 may use the document creation system 100 to generate documents, such as clinic notes and may use the interview subsystem (or portal) to generate interviews and collect electronic interview information for incorporating into documents created by the document creation system 100.

In the illustrated embodiment, the interviewer (e.g., referred physician 1010) has created three electronic interviews, a referral interview, a parent interview, and a patient interview. These electronic interviews are made available to the referring physician 1002, the parent 1004, and the patient 1006. The electronic interviews may be presented contemporaneously (e.g., in parallel) or serially. If presented serially, the responses received from the referring physician 1002 may be used to determine whether the referred patient is eligible as a patient to the referred physician 1010. If the referred patient is ineligible based on the responses, the parent interview may not be provided to the parent 1004 and/or the patient 1006. Once an interview (or a workflow of interviews) is complete, the responses to the interview(s) (or workflow) are submitted, for example to the document creation system 100. The electronic interview data may be available for insertion by the interviewer (e.g., referred physician 1010) into a document being generated using the document creation system 100. In other embodiments, the electronic interview data for an interview or for all the interviews of a workflow may be automatically composed by the document creation system 100 as discrete entries of a new document (e.g., a clinic note document).

The referred physician 1010 may augment or edit a document during a patient visit. In other words, the referred physician 1010 may chart in a document, such as in a clinic note, the diagnosis and treatment determined during the visit.

In another use case, the referred physician 1010 may generate an electronic interview for gathering post-visit follow-up information. The electronic interview may be sent to one or more of the interviewees (e.g., the referring physician 1002, the parent 1004, the patient 1006), and electronic interview data can be received in response that can then be added to a document, such as the clinic note edited during the patient 1006 visit. For example, the referred physician 1010 may seek to follow up on the result of a treatment prescribed. The referred physician 1010 may seek final results of a follow-on visit back from the referring physician 1002. An interviewer (e.g., the referred physician 1010) may also generate a post-visit electronic interview to deliver discharge instructions, educational videos, a recording from the physician, and/or a consent form. The electronic interview can include links to content that can be downloaded.

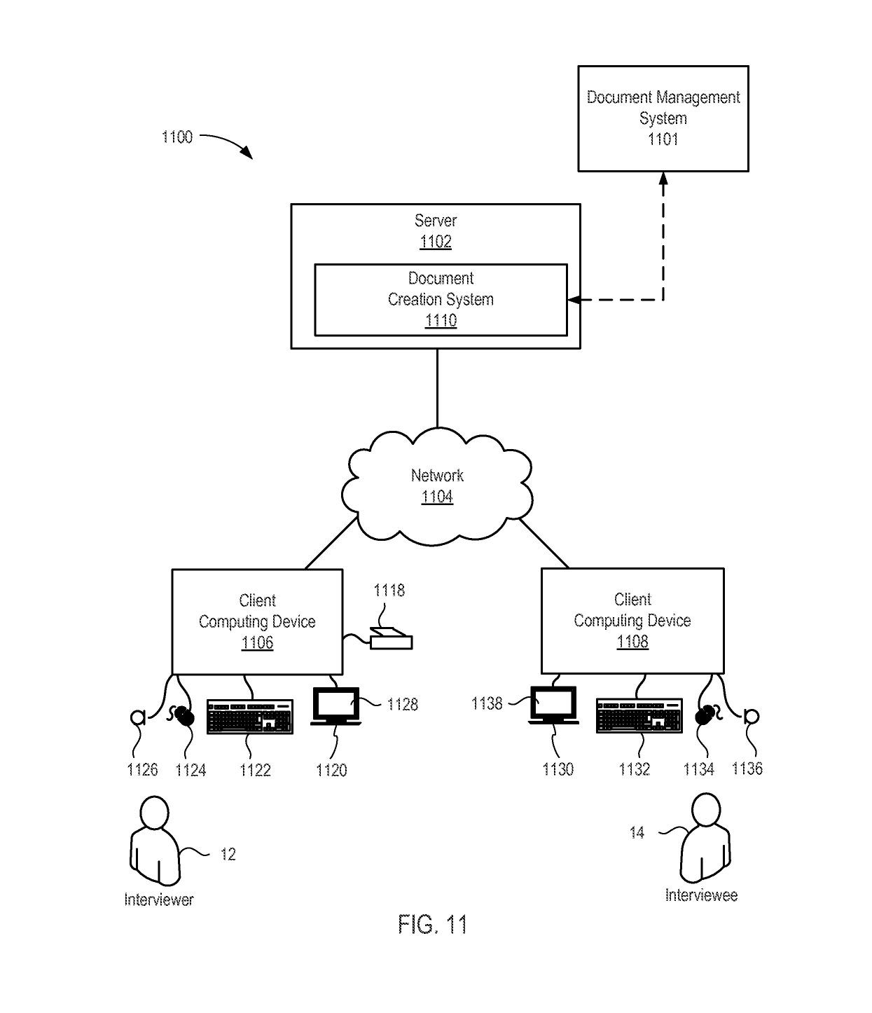

FIG. 11 is a block diagram of a system 1100 for creating a document, according to one embodiment of the present disclosure. The system 1100 may be deployed as a client-server model. The system 1100 may comprise a server 1102 (or other computing device), a network 1104, a first client computing device 1106 (e.g., an interviewer client computing device 1106), and a second client computing device 1108 (e.g., an interviewee client computing device 1108). The client computing devices 1106, 1108 may include one or more output components such as a printer 1118 and a display 1120, 1130. The client computing devices 1106, 1108 may also include one or more input components such as a keyboard 1122, 1132, a mouse 1124, 1134, a microphone 1126, 1136, and a touchscreen 1128, 1138. The server 1102 may also include one or more output and/or input components.

The interviewer 12 may access the system 1100 from the first client computing device 1106 to create an electronic interview. The interviewer 12 may also use electronic interview data to generate a document.

The interviewee 14 may access an interview and provide information as electronic interview data through the second client computing device 1108.

One or more of the system components, including but not limited to an input subsystem 120, a document generator subsystem 122, a processing subsystem 126, a data port subsystem 130, and an interview subsystem 132, as explained with reference to FIGS. 1A and 1B, may be embodied on the server 1102 as a document creation system 1110. The system 1100 may include, or alternatively interface with, an external document management system 1101. For example, the system 1100 may convert documents to a suitable format for, and/or communicate documents to, a document management system 1101 such as an electronic medical records (EMR) system.

The server 1102 may be any suitable computing device configured to process (e.g., store, retrieve, modify, and/or the like) data. In various exemplary embodiments, the server 1102 may comprise one or more processors (e.g., x86 instruction set based processors, SPARC processors, PowerPC processors, reduced instruction set computing (RISC) processors, and/or the like), communication interfaces (e.g., transmission control protocol/internet protocol (TCP/IP) interfaces, Ethernet interfaces, wired interfaces, wireless interfaces, and/or the like), data storage components (e.g., disk drives, memory, and/or the like), and/or software (e.g., operating systems, application software, and/or the like).

The document creation system 1110 of server 1102 may be similar to the document creation system 100 shown in FIGS. 1A and 1B, as described above. The server 1102 may be configured to communicate with the one or more client computing devices 1106, 1108. For example, a user interface of an input subsystem of the document creation system 1110 may be deployed as a web application, such that a user interface of the input subsystem is served to the one or more client computing devices 1106, 1108 as a web page, and input provided to the web page is communicated back to the server 1102.

The one or more client computing devices 1106, 1108 may be any computing device configured for interaction with a user. In one embodiment, a client computing device 1106, 1108 may comprise a personal computer with a general-purpose operating system (for example, Microsoft Windows) operative thereon. However, a client computing device 1106, 1108 may comprise any server, desktop computer, laptop, netbook, smartphone, thin client, and/or the like, suitable for allowing interaction with the network 1104, the server 1102, and/or the document creation system 1110. The client computing devices 1106, 1108 may comprise a browser to present a web interface served from the server 1102 and to enable user input.

The various parts of the system 1100 may be communicatively coupled via any suitable means, for example via an electronic communication network 1104. The network 1104 may comprise multiple sub-networks, computers, servers, routers, and/or the like, as known in the art. In one embodiment, the network 1104 is a TCP/IP network (e.g., the Internet). Moreover, the network 1104 may comprise any suitable components configured to allow communication between the client computing devices 1106, 1108 and the server 1102.

The document creation system 1100 may also suitably interface with any number and/or type of external systems, for example, systems configured for data processing and external document management systems 1101 (e.g., an electronic medical record (EMR) system). Because document entries are stored separately and discretely, processing of entries can be flexible and involve any number of internal and/or external processing subsystems 126 (see FIG. 1B). For example, the system 1100 may be configured to enable parallel data processing, by routing a first entry to a first processing subsystem and routing a second entry to a second processing subsystem. In another example, a system 1100 may be configured to route processing of sensitive and/or private data separately from processing of non-sensitive and/or public data.

As will be appreciated, in another embodiment, the document creation system 1110 may be operable on one or more of the client computing devices 1106, 1108. For example, the input subsystem 120 (see FIGS. 1A-1C) may be operative on the client computing device 1106, 1108 and provide composed entries to the document generator subsystem operating on the server 1102.

The document creation system 1110 is configured to allow data input via multiple channels, as described above. In an exemplary embodiment, the document creation system 1110 allows data input by mouse clicks (e.g., clicks to indicate entry of “normals,” i.e., default, custom, or expected responses to a query, and the like), by embedded dictation, via touch, and/or by free text entry. An interface supporting clicking, touching, talking, and/or typing improves user efficiency, for example by allowing the user to move from recording narrative (e.g., a dictation snippet) to clicking normals and back to recording without the need to stop or save midstream. Additionally, this interface allows editing of any element once it is added to a document. Conceptually, this interface simulates free-form dictation, allowing the user to dictate quickly from element to element. Additionally, the interface and/or templates may be modified, as desired, for example to support custom normals. In this manner, dictation of often repeated normals may be reduced and/or eliminated.

Moreover, in various exemplary embodiments, the document creation system 1110 is configured to support use of a digital pen and paper. For example, a physician may utilize a digital pen to initiate a new document session and note normals at the bedside in order to increase quality time with a patient. Resulting data may suitably be transferred from the digital pen to the document creation system 1110 via any suitable method, for example in a wireless manner via Bluetooth or Wi-Fi. In this manner, physician time spent at the computer may be reduced, as a digital document may be pre-populated with data for normals, notes for referral, and/or the like, reducing the amount of computer time needed to complete documentation during and/or after a patient visit.

The document creation system 1110 may be configured to support dictation. In various exemplary embodiments, the document creation system 1110 may be configured to support recording, transcription, retrieval, and/or any other desired operations on dictation snippets (for example, dictation snippets pertaining to a single portion of a template within the document creation system 1110). When recorded, dictation snippets may be immediately transferred to a database associated with the document creation system 1110, reducing the risk of data corruption or loss. In contrast, in freeform dictation, audio is often only saved after completion of the entire audio record, resulting in more frequent information loss due to the extended time between saves.

The document creation system 1110 may be further configured to support parallel processing of dictation snippets. In various exemplary embodiments, a user of the document creation system 1110 may input multiple dictation snippets in connection with an event, for example a clinical interview with a patient. Because each dictation snippet may be stored and/or processed individually, a particular snippet may be uploaded and delivered for transcription immediately, rather than waiting for additional snippets associated with the same document session. Moreover, dictation snippets from one documentation session may be separated and delivered to many transcriptionists in a parallel fashion, reducing transcription turn-around time.

Additionally, because dictation snippets may be separated as desired, particular dictation snippets needing increased oversight and/or security (e.g., dictation snippets containing personally identifiable information, and the like) may be processed in a first manner, and other dictation snippets needing less oversight and/or security (e.g., dictation snippets containing general information, diagnostic information, and/or the like) may be processed in a second manner different from the first manner. In an exemplary embodiment, each dictation snippet is indexed by a document session ID and a dictation ID. Thus, the dictation snippet may not be directly relatable to a physician and/or a patient. Moreover, dictation snippets may be configured to not carry patient health information. This de-identification of a dictation snippet may allow for secure transfer of dictation to transcriptionists or other service providers, and can result in additional cost savings and/or enhanced patient and physician confidentiality and/or privacy.

Further, in various exemplary embodiments, the document creation system 1110 may be configured to link dictation snippets within a document where they were placed by a system user. Moreover, these dictation snippets may be stored with a finalized document in perpetuity. Linking the documentation snippets in-line with document content can create a more complete document to be entered into the patient record. Additionally, the original words, narrative, and/or intent of the author may be better preserved by keeping dictation snippets embedded within the finalized (and fully transcribed) document.

In certain exemplary embodiments, the document creation system 1110 is configured with a built-in transcription module. In this manner, audio data may be integrated into a document. For example, dictation snippets captured by a recorder of the document creation system 1110 may be transcribed, and the resulting text may be integrated into a particular location within a document, for example a location defined by a template. Transcription may be performed by any suitable entity, at any suitable location, and/or at any suitable time, as desired. For example, a dictation snippet may be stored, and later transcribed by the individual who created the dictation, for example a physician. Moreover, a dictation snippet may be transcribed by a physician's staff member, an external transcription service provider, and/or a provider of the document creation and management system, as desired. For example, a provider of the document creation system 1110 may also offer transcription services in order to offer a physician a one-stop digital documentation solution, reducing the risk of data breaches or other unauthorized or undesired access to patient information.

Moreover, in certain embodiments, the document creation system 1110 may be configured with speech recognition capability, allowing instant transcription of dictation snippets. For example, a user may utilize audio capture capabilities of the document creation system 1110 to store dictation. Audio information captured by the document creation system 1110 may be immediately delivered to a speech recognition module, and the resulting automated transcription may be stored and/or displayed, as desired. Moreover, speech recognition capability may be implemented at any suitable location within the system 1100, for example on the client computing devices 1106, 1108, on the server 1102, or on a remote computing device, and so forth.

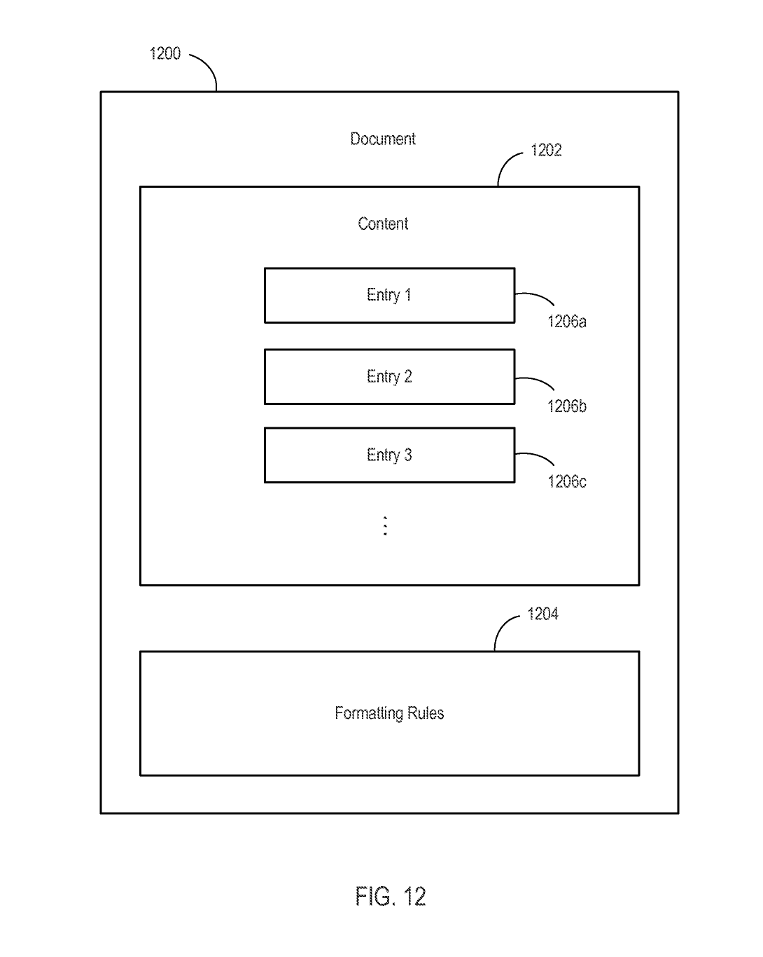

FIG. 12 is a block diagram of one embodiment of a document 1200, according the present disclosure. The diagram illustrates that a document 1200 includes content 1202 and formatting rules 1204. The document 1200 may further include other components, which are not illustrated in FIG. 12, including, for example, headers, footers, security features (e.g., permissions, digital rights management, etc.), routing rules for processing, encryption, document status information (e.g., preliminary, finalized), and the like. The content 1202 of the document 1200 may be stored as individual, discretely stored entries 1206a, 1206b, 1206c in association. In one embodiment, the document 1200 may be stored in a relational database as an element of a table providing information associating various document entries 1206a, 1206b, 1206c. The association information of the document 1200 may then refer to the individual document entries 1206a, 1206b, 1206c stored separately and discretely.

As mentioned previously, storing the entries discretely can enable improved data privacy and confidentiality, or otherwise enable compliance with data security requirements and privacy/confidentiality laws (e.g., HIPAA, HITECH). Storing entries discretely may allow delivery of one or more entries to a processing subsystem entity (e.g., a transcription service, editing service) without attaching identifying demographic information, which provides a layer of security both for a user of the document creation and management system or method and for the subject (e.g., a patient) of the document. Entries can be processed individually and without any information about a subject (e.g., a patient) of the document, assuming the document relates to a person. Storing entries discretely as separate objects also can enable improved processing efficiency by allowing delivery of one or more entries to one or more separate processing entities. Accordingly, entries can be processed in parallel, thereby enhancing efficiency of the method and/or system as a whole.

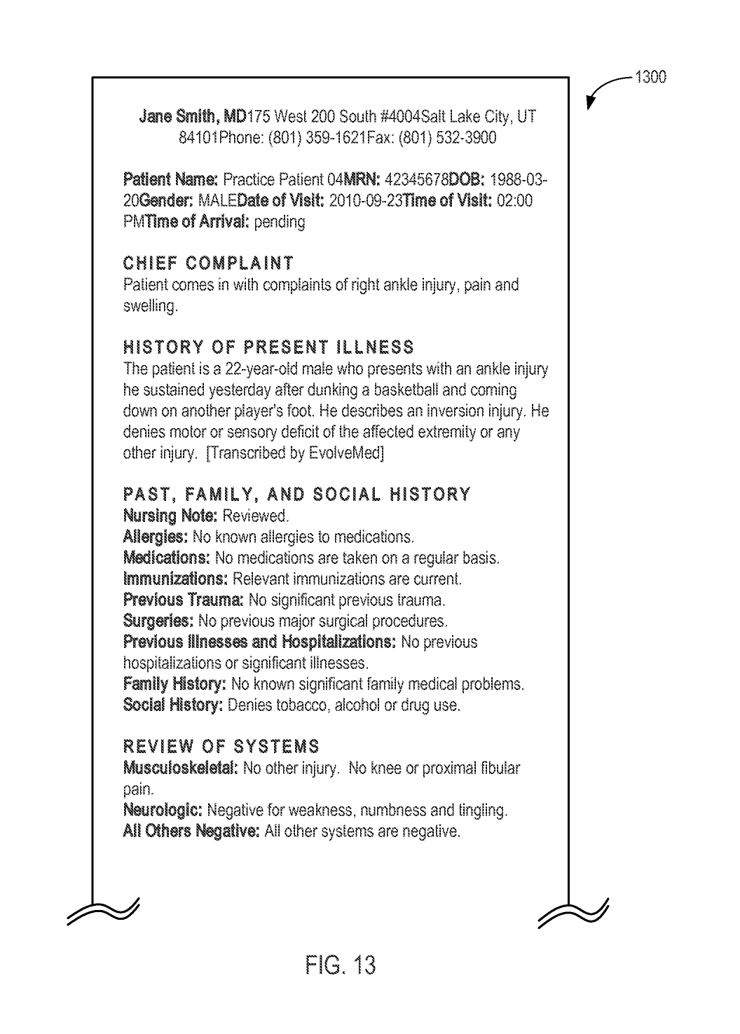

FIG. 13 illustrates an output document 1300 (e.g., a patient interaction record) generated by a document creation and management system, according to one embodiment. The output document 1300 may be generated by providing input data according to a document template. The input data may be stored as entries. The output document 1300 presents the entries according to the formatting rules of the document and/or entries. As can be appreciated, other formats, configurations, record types, and/or the like, and not only patient interaction reports and/or other medical records, are considered to be within the scope of the present disclosure.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification, are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. Elements recited in means-plus-function format are intended to be construed in accordance with 35 U.S.C. §112, ¶6.

It will be apparent to those having skill in the art that changes may be made to the details of the above-described embodiments without departing from the underlying principles of the invention. Embodiments of the invention in which an exclusive property or privilege is claimed are defined as follows in the claims.

1. A computer-implemented method of document creation, comprising:
generating at a computing device an electronic interview including a query to be presented and a corresponding interview input component configured to receive electronic interview data pertaining to the query;
establishing at the computing device a mapping for the interview input component, the mapping corresponding to a mapping of an element of a given template of a document creation system, wherein the mapping is to be assigned to electronic interview data that is received through the interview input component;
providing interviewee access to the electronic interview;
receiving at the computing device electronic interview data provided via the interview input component in response to the query of the electronic interview; and
creating, by the document creation system, a document according to the given template of the document creation system, the given template customizable by a given user of the document creation system and specifying input to be gathered as content of the document, the content comprising one or more discrete entries, wherein at least one discrete entry of the one or more discrete entries includes a portion of the electronic interview data.

2. The computer-implemented method of claim 1, wherein providing interviewee access to the electronic interview comprises providing the electronic interview for access from an interviewee client computing device, wherein the electronic interview can be presented on the interviewee client computing device to the interviewee.

3. The computer-implemented method of claim 1, wherein the electronic interview data is received at the computing device from a remote interviewee client computing device coupled to the computing device via a network.

4. The computer-implemented method of claim 1, wherein providing interviewee access to the electronic interview includes providing to a client computing device a graphical user interface for presenting the electronic interview.

5. The computer-implemented method of claim 1, wherein the query of the electronic interview is configured according to first input data received at the central computing device from an interview creation client computing device coupled to the computing device via a network, and wherein the mapping for the interview component is defined by second input data received at the central computing device from the interview creation client computing device.

6. The computer-implemented method of claim 1, wherein creating the document comprises:
presenting a graphical user interface for the document creation system, the user interface comprising a document input component that is mapped to the element of the given template;
in response to actuation of the document input component of the user interface of the document creation system, composing the electronic interview data as a discrete entry; and
generating the document at the central computing device using a plurality of discrete entries, including the discrete entry composed from the electronic interview data.

7. The computer-implemented method of claim 6, wherein composing the electronic interview data as a discrete entry comprises:
in response to initial actuation of the document input component of the user interface of the document creation system, presenting the electronic interview data for review by a document creator; and
composing the electronic interview data as a discrete entry of the content of the document being created in response to a subsequent second actuation of the document input component of the user interface.

8. The computer-implemented method of claim 1, wherein the mapping for the interview input component and the mapping of the element of the given template of the document creation system both correspond to an element of an electronic medical record system,
wherein the one or more discrete entries of the content of the document are mapped to one or more elements of the electronic medical record system, and
wherein the method further comprises translating the document into an electronic medical record configured to be stored in the electronic medical record system.

9. The computer-implemented method of claim 1, further comprising:
receiving input from the given user of the document creation system specifying preferences for the given template of the document creation system; and
generating the given template according to the preferences of the given user of the document creation system to customize the template.

10. A document creation system, comprising:
a template to guide creation of content of a document, the template customizable by a given user interviewer of the document creation system and specifying input to be gathered as content of the document;
an interview creator subsystem to generate an electronic interview to be presented, the electronic interview including a query to be presented to an interviewee and a corresponding interview input component configured to receive electronic interview data pertaining to the query from the interviewee, the interview creator subsystem configured to create a mapping to map the interview input component to an element of the template, wherein the mapping is assigned to electronic interview data that is received through the interview input component; and
an interview portal subsystem to enable presentation of the electronic interview to the interviewee, including presenting the query and the interview input component, and to receive electronic interview data that is provided by the interviewee via the interview input component in response to the query of the electronic interview;
wherein the document creation system is configured to generate a document according to the template, the content of the document comprising one or more discrete entries, wherein at least one discrete entry of the one or more discrete entries includes a portion of the electronic interview data.

11. The system of claim 10, further comprising:
an input subsystem to compose the received electronic interview data into a discrete entry to create content of the document, the discrete entry to be stored discretely from other of the one or more discrete entries of the content of the document; and
a document generator subsystem to generate the document according to the template using the one or more discrete entries.

12. The system of claim 11, wherein the input subsystem is configured to provide a user interface for the document creation system, the user interface comprising a document input component mapped to the element of the template, the document input component being actuatable to present the electronic interview data received through the interview input component as preconfigured data for insertion into the document generated by the document creation system, wherein the document input component is further actuatable to compose the received electronic interview data into a discrete entry to create content of the document.

13. The system of claim 10, wherein the query to be presented to the interviewee is defined by interviewer input.

14. The system of claim 10, wherein the interview portal subsystem is configured to present the electronic interview to the interviewee by providing interviewee access to the electronic interview.

15. The system of claim 14, wherein providing interviewee access to the electronic interview comprises enabling access to the electronic interview from an interviewee client computing device.

16. The system of claim 10, further comprising a template editor to enable interviewer creation and customization of the template.

17. A computer-readable medium having stored thereon instructions that, when executed by a computing device, cause the computing device to perform operations comprising:
generating an electronic interview including a query and a corresponding interview input component configured to receive electronic interview data pertaining to the query;
establishing a mapping for the interview input component, the mapping corresponding to a mapping of an element of a template of a document creation system, wherein the mapping is assigned to electronic interview data that is received through the interview input component;
receiving electronic interview data provided via the interview input component in response to the query of the electronic interview; and
creating a document according to the given template of the document creation system, the template customizable by a given user of the document creation system, the template specifying input to be gathered as content of the document, the content comprising one or more discrete entries, wherein at least one discrete entry of the one or more discrete entries includes a portion of the electronic interview data.

18. The computer-readable medium of claim 17, wherein the operations further comprise providing interviewee access to the electronic interview.

19. The computer-readable medium of claim 18, wherein providing interviewee access to the electronic interview comprises publishing the electronic interview for access from an interviewee client computing device.

20. The computer-readable medium of claim 18, wherein providing interviewee access to the electronic interview includes providing, over a network to a client computing device, a graphical user interface for presenting the electronic interview.

21. The computer-readable medium of claim 17, wherein receiving the electronic interview data comprises receiving the electronic data from a remote interviewee client computing device via a network.

22. The computer-readable medium of claim 17, further comprising:
configuring the query of the electronic interview according to first input data received at the computing device over a network from an interview creation client computing device coupled to the computing device via a network; and
defining the mapping for the interview component according to second input data received at the computing device from the interview creation client computing device.

23. The computer-readable medium of claim 17, wherein the operation of creating the document comprises the operations of:
presenting a graphical user interface for the document creation system, the user interface comprising a document input component that is mapped to the element of the given template;
in response to actuation of the document input component of the user interface of the document creation system, composing the electronic interview data as a discrete entry; and
generating the document at the central computing device using a plurality of discrete entries, including the discrete entry composed from the electronic interview data.

24. The computer-readable medium of claim 23, wherein the operation of composing the electronic interview data as a discrete entry comprises the operations of:
in response to initial actuation of the document input component of the user interface of the document creation system, presenting the electronic interview data for review by a document creator; and
composing the electronic interview data as a discrete entry of the content of the document being created in response to a subsequent second actuation of the document input component of the user interface.

25. The computer-readable medium of claim 17, wherein the operations further comprise generating the given template according to input received from the given user of the document creation system to customize the template to preferences of the given user.
